(19) United States
(12) Patent Application Publication
(10) Pub. No.: US 2024/0286638 A1
(43) Pub. Date: Aug. 29, 2024

(54) AUTONOMOUS VEHICLE CONTROL BASED ON HAND SIGNAL INTENT DETECTION

(71) Applicant: TuSimple, Inc., San Diego, CA (US)

(72) Inventor: Shivam Kranti Gupta, Fremont, CA (US)

(21) Appl. No.: 18/435,207

(22) Filed: Feb. 7, 2024

Related U.S. Application Data
(60) Provisional application No. 63/486,499, filed on Feb. 23, 2023.

(51) Int. Cl. B60W 60/00; G06V 10/77; G06V 10/776; G06V 20/58; G06V 40/20

(52) U.S. Cl. CPC B60W 60/001; G06V 10/7715; G06V 20/58; G06V 40/28; B60W 2420/403; B60W 2420/408; B60W 2552/53; B60W 2554/404; B60W 2556/45; G06V 10/776

(57) ABSTRACT

A control device associated with an autonomous vehicle detects that a person is altering traffic on a road using a hand signal. The control device determines an interpretation of the hand signal. The control device transmits the hand signal interpretation to an oversight server. The oversight server verifies the hand signal interpretation and communicates an instruction to navigate the autonomous vehicle according to the verified hand signal interpretation. The control device determines a proposed trajectory for the autonomous vehicle according to the interpretation of the hand signal. The control device navigates the autonomous vehicle according to the proposed trajectory.

This application claims priority to U.S. Provisional Patent Application No. 63/486,499 filed Feb. 23, 2023 and titled “AUTONOMOUS VEHICLE CONTROL BASED ON HAND SIGNAL INTENT DETECTION,” which is incorporated herein by reference.

### TECHNICAL FIELD

The present disclosure relates generally to autonomous vehicles. More particularly, the present disclosure is related to autonomous vehicle control based on hand signal intent detection.

### BACKGROUND

One aim of autonomous vehicle technology is to provide vehicles that can safely navigate with limited or no driver assistance. In some situations, a person, such as a construction worker or a law enforcement officer may alter or direct traffic using hand signals or a hand-held sign. Without a human driver, it is challenging to determine the intent of the hand signals or the hand-held sign.

### SUMMARY

This disclosure recognizes various problems and previously unmet needs related to autonomous vehicle navigation, and more specifically to the lack of technology to efficiently detect hand signals (and hand-held signs) when used to direct or alter the traffic flow on a road where the autonomous vehicle is traveling. In an example scenario, assume that an autonomous vehicle is traveling on a road and encounters a person who is altering the traffic using hand signals (or a hand-held sign). Without determining the interpretation of the hand signal (or the hand-held sign), the autonomous vehicle would not be able to abide by the traffic control instruction provided by the person. This may lead to unsafe driving conditions for the autonomous vehicle and other vehicles on the road, and unsafe road environment for pedestrians in that vicinity.

Certain embodiments of the present disclosure provide unique technical solutions to technical problems of current autonomous vehicle technologies, including those problems described above to improve the autonomous vehicle navigation, specifically in situations where hand signals (or hand-held signs) are used to alter or direct the traffic. The present disclosure contemplates systems and methods for autonomous vehicle control based on hand signal intent detection.

In an example scenario, assume that an autonomous vehicle is traveling on a road where someone is altering the traffic flow using a hand signal and/or a hand-held sign. The disclosed system is configured to detect the hand signal and/or the hand-held sign, determine what the hand signal and/or the hand-held sign means (i.e., the interpretation of the hand signal and/or the hand-held sign), determine a proposed trajectory for the autonomous vehicle according to the observed hand signal and/or the hand-held sign, and instruct the autonomous vehicle to perform the proposed trajectory.

The disclosed system may determine the interpretation of the hand signal using a hand signal detection machine learning module that is pre-trained to predict interpretations of various hand signals from sensor data. The disclosed system may determine the proposed trajectory for the autonomous vehicle according to the interpretation of the hand signal. In certain embodiments, the proposed trajectory may follow the interpretation of the hand signal. For example, if the hand signal means all vehicles stop, the proposed trajectory may be to stop the autonomous vehicle.

In certain embodiments, a control device that resides in the autonomous vehicle may have the autonomy to navigate the autonomous vehicle independently according to the proposed trajectory. In certain embodiments, the control device may have partial autonomy and may need confirmation on the hand signal interpretation from an oversight server. For example, the control device may transmit the sensor data and/or the hand signal interpretation to the oversight server. The oversight server may be implemented by distributed cloud computing and therefore have more computation resources compared to the control device that is onboard the autonomous vehicle. The oversight server may implement a cloud-based hand signal detection machine learning module to confirm, update, or override the hand signal interpretation. In this manner, the disclosed system improves the autonomous vehicle technology, specifically in situations where a hand signal and/or a hand-held sign is used to control or alter traffic on a road. In certain embodiments, the control device may communicate the proposed trajectory to the oversight server. The oversight server may confirm, update, or override the proposed trajectory. The oversight server may communicate navigation instructions to the control device based on the confirmed hand signal interpretation. The control device may navigate the autonomous vehicle according to the received navigation instructions.

Accordingly, the disclosed system provides the practical application of improving the autonomous vehicle navigation technology by enabling the autonomous vehicle to determine the interpretation of an observed hand signal and/or a hand-held sign and determining a safe traveling path for the autonomous vehicle accordingly. For example, the routing plan of the autonomous vehicle may be updated according to the prescribed trajectory which follows the observed hand signal and/or the hand-held sign interpretation.

The disclosed system may be attuned to detect hand signals and hand-held signs used by law enforcement personnel, emergency personnel, construction workers, school zone crosswalk safety personnel, a crossing guard, and generally people who are known to use hand signals and/or hand-held signs. The disclosed system may be attuned to detect hand signals and hand-held signs in particular areas where it is known that hand signals and/or hand-held signs may be used to alter or guide traffic. The particular areas may be school zones, construction zones, road closures, road accident zones, and the like. In response to determining that the autonomous vehicle is approaching such areas, the disclosed system may prioritize analyzing the sensor data for hand signal/hand-held sign detection. In this manner, the disclosed system implements additional safety measures to determine a safer navigation plan for the autonomous vehicle. This, in turn, provides a safer driving experience for the autonomous vehicle and its surrounding vehicles, and assist in protecting the pedestrians on the road.

In one embodiment, a system comprises a memory operably coupled with a processor. The memory is configured to store sensor data that provides information about a road ahead of an autonomous vehicle, wherein the sensor data is captured by at least one sensor associated with the autonomous vehicle. The processor is associated with the autonomous vehicle. The processor is configured to access the sensor data. The processor is further configured to determine that the sensor data comprises an indication of a person altering a traffic flow using a hand signal. The processor is further configured to determine an interpretation of the hand signal. The processor is further configured to determine a pose associated with the person. The processor is further configured to determine that the hand signal is in use to alter the traffic flow based at least in part upon the determined interpretation of the hand signal and the determined pose associated with the person. The processor is further configured to communicate the sensor data and the determined interpretation of the hand signal along with a first query message to an oversight server, wherein the first query message requests to verify the determined interpretation of the hand signal. The processor is further configured to receive a first message that indicated that the determined interpretation of the hand signal is verified from the oversight server. The processor is further configured to determine a proposed trajectory for the autonomous vehicle according to the determined interpretation of the hand signal. The processor is further configured to determine, from the sensor data, whether any obstruction prevents navigating the autonomous vehicle according to the proposed trajectory. The processor is further configured to in response to determining that no obstruction is present that prevents navigating the autonomous vehicle according to the proposed trajectory, navigate the autonomous vehicle according to the proposed trajectory.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to navigate an autonomous vehicle in response to a detected hand signal/hand-held sign;

FIG. 2 illustrates an embodiment of a method for navigating an autonomous vehicle in response to a detected hand signal/hand-held sign;

FIG. 3 illustrates a block diagram of an example autonomous vehicle configured to implement autonomous driving operations;

FIG. 4 illustrates an example system for providing autonomous driving operations used by the autonomous vehicle of FIG. 3; and

FIG. 5 illustrates a block diagram of an in-vehicle control computer included in the autonomous vehicle of FIG. 3.

### DETAILED DESCRIPTION

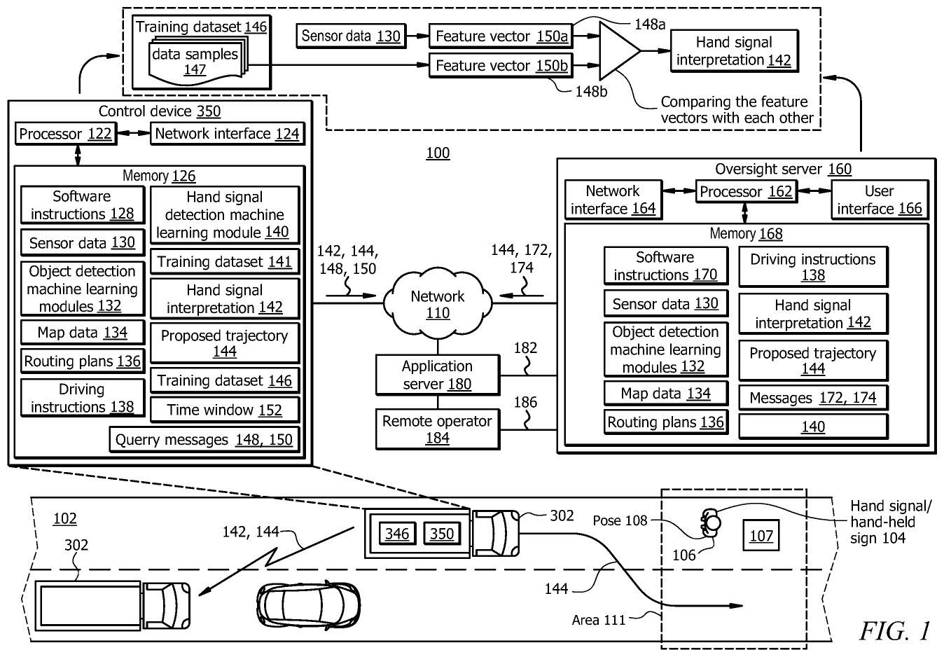

As described above, previous technologies fail to provide efficient, reliable, and safe solutions to navigate an autonomous vehicle in response to a detected hand signal/hand-held sign that is used to alter or guide traffic flow on a road. The present disclosure provides various systems, methods, and devices to navigate an autonomous vehicle in response to a detected hand signal/hand-held sign that is used to alter or guide traffic flow on a road. Embodiments of the present disclosure and its advantages may be understood by referring to FIGS. 1 through 5. FIGS. 1 through 5 are used to describe a system and method to navigate an autonomous vehicle in response to a detected hand signal/hand-held sign that is used to alter traffic on a road.

### System Overview

FIG. 1 illustrates an embodiment of a system 100 configured to determine an interpretation of a hand signal 104 or a hand-held sign 104 experienced by an autonomous vehicle 302, where the hand signal 104 or the hand-held sign 104 is used to alter or guide the traffic flow on a road 102, determine a proposed trajectory according to the hand signal 104 or the hand-held sign 104, and navigate the autonomous vehicle 302 according to the proposed trajectory. FIG. 1 further illustrates a simplified schematic of a road 102 traveled by an autonomous vehicle 302, where the autonomous vehicle 302 encounters or experiences a hand signal 104 or a hand-held sign 104. In this disclosure, operations that are described in response to detecting a hand signal 104 may be performed in response to detecting a respective or corresponding hand-held sign 104 that may convey the same interpretation 142 as the hand signal 104. In certain embodiments, system 100 comprises an autonomous vehicle 302 communicatively coupled with one or more autonomous vehicles 302, an oversight server 160, and an application server 180 via a network 110. Network 110 enables communication among the components of the system 100. Network 110 allows the oversight server 160 to communicate with autonomous vehicles 302, systems, application server 180, databases, devices, etc. Network 110 also allows the autonomous vehicle 302 to communicate with other autonomous vehicles 302, systems, oversight server 160, application server 180, databases, devices, etc. The autonomous vehicle 302 comprises a control device 350. Control device 350 comprises a processor 122 in signal communication with a memory 126. Memory 126 stores software instructions 128 that when executed by the processor 122, cause the control device 350 to execute one or more operations described herein. Oversight server 160 comprises a processor 162 in signal communication with a memory 168. Memory 168 stores software instructions 170 that when executed by the processor 162, cause the oversight server 160 to perform one or more operations described herein. In other embodiments, system 100 may not have all of the components listed and/or may have other elements instead of, or in addition to, those listed above. System 100 may be configured as shown or in any other configuration.

Vehicles traversing highways and roadways are legally required to comply with regulations and statues in the course of safe operation of a vehicle. For autonomous vehicles 302, particularly autonomous tractor trailers, the ability to recognize a malfunction in its systems, recognize instructions given by law enforcement or other authorized personnel, recognize instructions given by hand signals or hand-held signs, and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

In an example scenario, assume that an autonomous vehicle 302 is traveling on a road 102 where someone is altering the traffic flow using a hand signal 104 and/or a hand-held sign 104. The system 100 (e.g., via the control device 350 and/or the oversight server 160) is configured to detect the hand signal 104 and/or the hand-held sign 104, determine what the hand signal 104 and/or the hand-held sign 104 means (i.e., the interpretation 142 of the hand signal 104 and/or the hand-held sign 104), determine a proposed trajectory 144 for the autonomous vehicle 302 according to the observed hand signal 104 and/or the hand-held sign 104, and instruct the autonomous vehicle 302 to perform a proposed trajectory 144.

In this manner, the disclosed system 100 improves the autonomous vehicle technology, specifically in situations where a hand signal 104 and/or a hand-held sign 104 is used to control or alter traffic on a road. For example, the routing plan 136 of the autonomous vehicle 302 may be updated according to the prescribed trajectory 144 which follows the interpretation 142 of the observed hand signal 104 and/or the hand-held sign 104.

The disclosed system 100 may be attuned to hand signals 104 and hand-held signs 104 used by law enforcement personnel, emergency personnel, construction workers, school zone crosswalk safety personnel, a crossing guard, and generally authorized personnel who are known to use hand signals and/or hand-held signs to direct or guide traffic in certain situations. The disclosed system 100 may be attuned to detect hand signals 104 and hand-held signs 104 in particular areas where it is known that hand signals 104 and/or hand-held signs 104 may be used to alter or guide traffic. The particular areas may be school zones, construction zones, road closures, road accident zones, and the like. These zones may be noted in a navigational map used by the system.

For example, the disclosed system 100 may implement a hand signal detection machine learning module 140 that is trained (using a training dataset 146) to determine that the autonomous vehicle 302 is approaching such areas and detect the interpretation of hand signals 104 and/or hand-held signs 104 used to control or otherwise guide the traffic. Additionally, map data 134 may be used by the system 100 to indicate to the machine learning module 140 that the autonomous vehicle 302 is approaching an area where hand signals may be used or have been known to be used. In response to determining that the autonomous vehicle 302 is approaching such areas where it is known that hand signals and/or hand-held signs are used to control the traffic, the disclosed system 100 may prioritize analyzing the sensor data 130 for hand signal/hand-held sign detection. In this manner, the disclosed system 100 implements additional safety measures to determine a safer navigation plan for the autonomous vehicle. This, in turn, provides a safer driving experience for the autonomous vehicle and its surrounding vehicles, and assist in protecting the pedestrians on the road.

### System Components

Network 110 may include any interconnecting system capable of transmitting audio, video, signals, data, messages, or any combination of the preceding. Network 110 may include all or a portion of a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMAX, etc.), a long term evolution (LTE) network, a universal mobile telecommunications system (UMTS) network, a peer-to-peer (P2P) network, a Bluetooth network, a near field communication (NFC) network, a Zigbee network, a Z-wave network, a WiFi network, and/or any other suitable network.

### Example Autonomous Vehicle

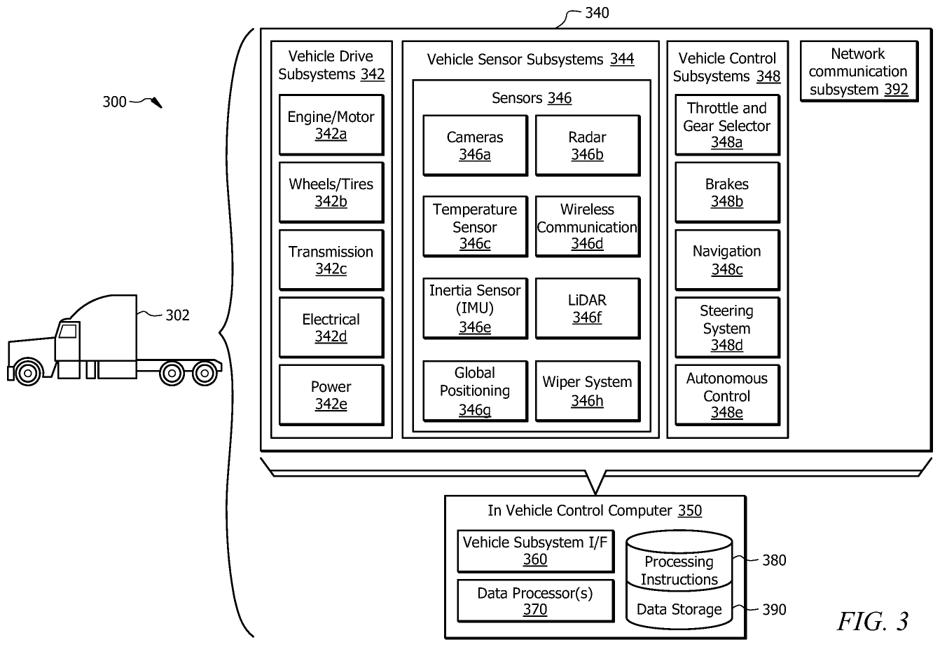

In one embodiment, the autonomous vehicle 302 may include a semi-truck tractor unit attached to a trailer to transport cargo or freight from one location to another location (see FIG. 3). The autonomous vehicle 302 is generally configured to travel along a road in an autonomous mode. The autonomous vehicle 302 may navigate using a plurality of components described in detail in FIGS. 3-6. The operation of the autonomous vehicle 302 is described in greater detail in FIGS. 3-6. The corresponding description below includes brief descriptions of certain components of the autonomous vehicle 302.

Control device 350 may be generally configured to control the operation of the autonomous vehicle 302 and its components and to facilitate autonomous driving of the autonomous vehicle 302. The control device 350 may be further configured to determine a pathway in front of the autonomous vehicle 302 that is safe to travel and free of objects or obstacles, and navigate the autonomous vehicle 302 to travel in that pathway. This process is described in more detail in FIGS. 3-6. The control device 350 may generally include one or more computing devices in signal communication with other components of the autonomous vehicle 302 (see FIG. 3). In this disclosure, the control device 350 may interchangeably be referred to as an in-vehicle control computer 350.

The control device 350 may be configured to detect objects on and around a road traveled by the autonomous vehicle 302 by analyzing the sensor data 130 and/or map data 134. For example, the control device 350 may detect objects on and around the road by implementing object detection machine learning modules 132. The object detection machine learning modules 132 may be implemented using neural networks and/or machine learning algorithms for detecting objects from images, videos, infrared images, point clouds, radar data, etc. The object detection machine learning modules 132 are described in more detail further below: The control device 350 may receive sensor data 130 from the sensors 346 positioned on the autonomous vehicle 302 to determine a safe pathway to travel. The sensor data 130 may include data captured by the sensors 346.

Sensors 346 may be configured to capture any object within their detection zones or fields of view, such as landmarks, lane markers, lane boundaries, road boundaries, vehicles, pedestrians, road/traffic signs, among others. In some embodiments, the sensors 346 may be configured to detect rain, fog, snow, and/or any other weather condition. The sensors 346 may include a detection and ranging (LiDAR) sensor, a radar sensor, a video camera, an infrared camera, an ultrasonic sensor system, a wind gust detection system, a microphone array, a thermocouple, a humidity sensor, a barometer, an inertial measurement unit, a positioning system, an infrared sensor, a motion sensor, a rain sensor, and the like. The sensor data 130 may include data feed for each type of sensor 346. For example, the sensor data 130 may include a video feed, an image feed, a LiDAR cloud data feed, an infrared data feed, a motion sensor data feed, or a Radar sensor data feed, among others. In some embodiments, the sensors 346 may be positioned around the autonomous vehicle 302 to capture the environment surrounding the autonomous vehicle 302. See the corresponding description of FIG. 3 for further description of the sensors 346.

### Control Device

The control device 350 is described in greater detail in FIG. 3. In brief, the control device 350 may include the processor 122 in signal communication with the memory 126 and a network interface 124. The processor 122 may include one or more processing units that perform various functions as described herein. The memory 126 may store any data and/or instructions used by the processor 122 to perform its functions. For example, the memory 126 may store software instructions 128 that when executed by the processor 122 causes the control device 350 to perform one or more functions described herein.

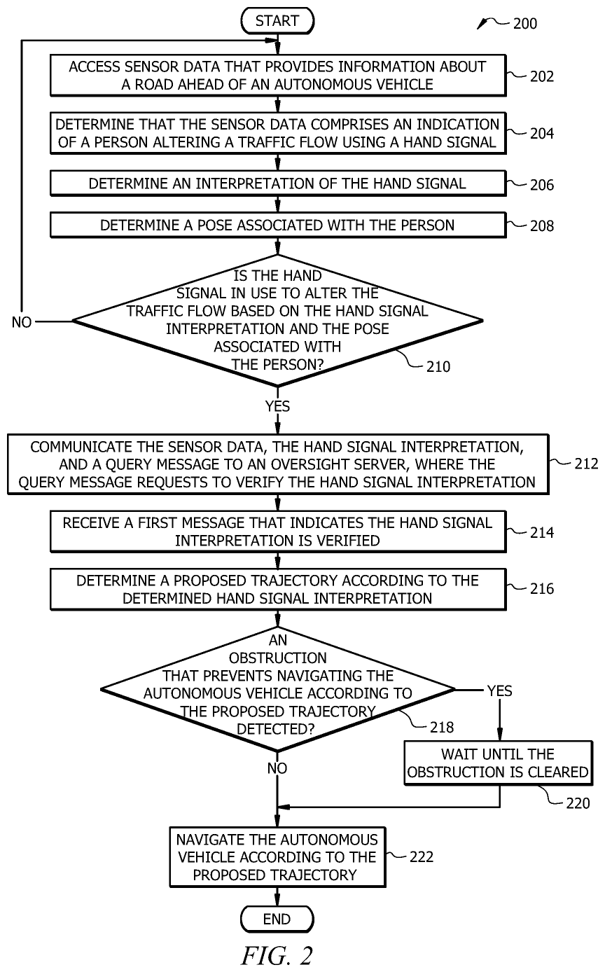

The processor 122 may be one of the data processors 370 described in FIG. 3. The processor 122 comprises one or more processors operably coupled to the memory 126. The processor 122 may be any electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors may be configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute software instructions 128 to implement the functions disclosed herein, such as some or all of those described with respect to FIGS. 1-5. In some embodiments, the function described herein is implemented using logic units, FPGAs, ASICs, DSPs, or any other suitable hardware or electronic circuitry. The processor 122 may be configured to perform one or more operations of the operational flow described in FIG. 1 and/or one or more operations of the method 200 described in FIG. 2.

Network interface 124 may be a component of the network communication subsystem 392 described in FIG. 3. The network interface 124 may be configured to enable wired and/or wireless communications. The network interface 124 may be configured to communicate data between the autonomous vehicle 302 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol as would be appreciated by one of ordinary skill in the art.

The memory 126 may be one of the data storages 390 described in FIG. 3. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 may store any of the information described in FIGS. 1-5 along with any other data, instructions, logic, rules, or code operable to implement the function(s) described herein when executed by processor 122. For example, the memory 126 may store software instructions 128, sensor data 130, object detection machine learning module 132, map data 134, routing plan 136, driving instructions 138, hand signal detection machine learning module 140, training dataset 141, hand signal interpretation 142, proposed trajectory 144, training dataset 146, query messages 148, 150, time window 152, and/or any other data/instructions. The software instructions 128 include code that when executed by the processor 122 causes the control device 350 to perform one or more functions described herein, such as some or all of those described in FIGS. 1-5. The memory 126 comprises one or more disks, tape drives, or solid-state drives, and may be used as an over-flow data storage device to store programs when such programs are selected for execution, and to store instructions and data that are read during program execution.

Object detection machine learning modules 132 may be implemented by the processor 122 executing software instructions 128, and may be generally configured to detect objects and obstacles from the sensor data 130. The object detection machine learning modules 132 may be implemented using neural networks and/or machine learning algorithms for detecting objects from any data type, such as images, videos, infrared images, point clouds, Radar data, etc.

In some embodiments, the object detection machine learning modules 132 may be implemented using machine learning algorithms, such as Support Vector Machine (SVM), Naive Bayes, Logistic Regression, k-Nearest Neighbors, Decision Trees, or the like. In some embodiments, the object detection machine learning modules 132 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the object detection machine learning modules 132. The object detection machine learning modules 132 may be trained by a training dataset 141 that may include samples of data types labeled with one or more objects in each sample. For example, the training dataset 141 may include sample images of objects (e.g., vehicles, lane markings, pedestrians, road signs, obstacles, etc.) labeled with object(s) in each sample image. Similarly, the training dataset 141 may include samples of other data types, such as videos, infrared images, point clouds, Radar data, etc. labeled with object(s) in each sample data. The object detection machine learning modules 132 may be trained, tested, and refined by the training dataset 141 and the sensor data 130. The object detection machine learning modules 132 use the sensor data 130 (which are not labeled with objects) to increase their accuracy of predictions in detecting objects. For example, supervised and/or unsupervised machine learning algorithms may be used to validate the predictions of the object detection machine learning modules 132 in detecting objects in the sensor data 130.

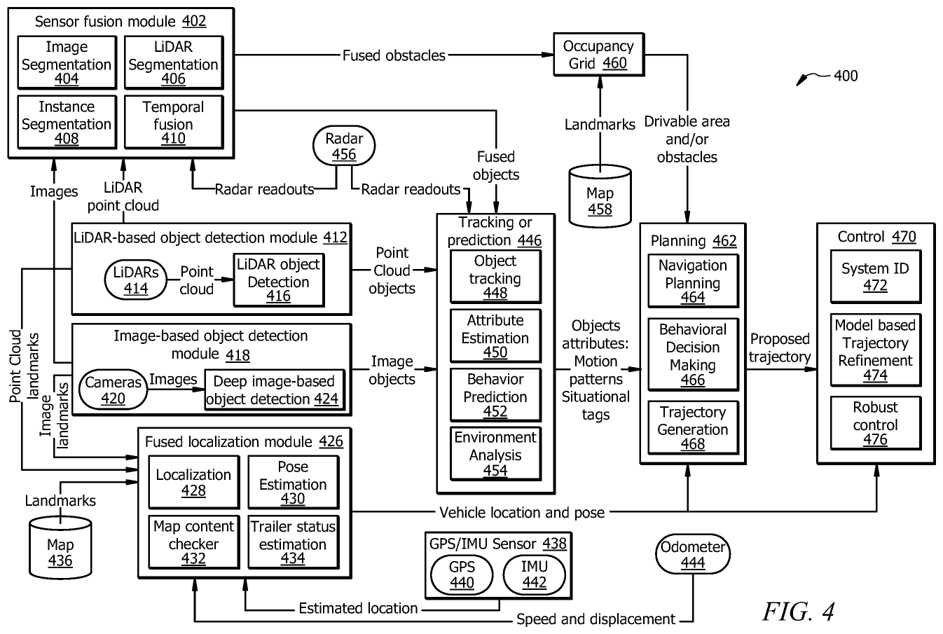

Map data 134 may include a virtual map of a city or an area that includes the road traveled by an autonomous vehicle 302. In some examples, the map data 134 may include the map 458 and map database 436 (see FIG. 4 for descriptions of the map 458 and map database 436). The map data 134 may include drivable areas, such as roads, paths, highways, and undrivable areas, such as terrain (determined by the occupancy grid module 460, see FIG. 4 for descriptions of the occupancy grid module 460). The map data 134 may specify location coordinates of road signs, lanes, lane markings, lane boundaries, road boundaries, traffic lights, obstacles, etc.

Routing plan 136 may be a plan for traveling from a start location (e.g., a first autonomous vehicle launchpad/landing pad) to a destination (e.g., a second autonomous vehicle launchpad/landing pad). For example, the routing plan 136 may specify a combination of one or more streets, roads, and highways in a specific order from the start location to the destination. The routing plan 136 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 136 may include other information about the route from the start position to the destination, such as road/traffic signs in that routing plan 136, etc.

Driving instructions 138 may be implemented by the planning module 462 (See descriptions of the planning module 462 in FIG. 4.). The driving instructions 138 may include instructions and rules to adapt the autonomous driving of the autonomous vehicle 302 according to the driving rules of each stage of the routing plan 136. For example, the driving instructions 138 may include instructions to stay within the speed range of a road traveled by the autonomous vehicle 302, adapt the speed of the autonomous vehicle 302 with respect to observed changes by the sensors 346, such as speeds of surrounding vehicles, objects within the detection zones of the sensors 346, etc.

Hand signal detection machine learning module 140 may be implemented by the processor 122 executing the software instructions 128, and may be generally configured to detect hand signals 104 and hand-held signs 104, and determine interpretations 142 (e.g., the intent) of the detected hand signals 104 and hand-held signs 104. The hand signal detection machine learning module 140 may be implemented using neural networks and/or machine learning algorithms for detecting hand signals 104 and hand-held signs 104 from any data type, such as images, videos, infrared images, point clouds, Radar data, etc. In some embodiments, the hand signal detection machine learning module 140 may be implemented using machine learning algorithms, such as SVM, Naive Bayes, Logistic Regression, k-Nearest Neighbors, Decision Trees, or the like. In some embodiments, the hand signal detection machine learning module 140 may utilize a plurality of neural network layers, convolutional neural network layers, LSTM layers, Bi-directional LSTM layers, recurrent neural network layers, and/or the like, in which weights and biases of these layers are optimized in the training process of the hand signal detection machine learning module 140.

The hand signal detection machine learning module 140 may be trained by a training dataset 146 that may include samples 147 of data types each labeled with a respective hand signal 104 or a hand-held sign 104 in each respective data sample 147. For example, the training dataset 146 may include sample images of people performing hand signals 104 and/or hand-held signs 104 (e.g., vehicles proceed, slow down, stop, pull over, etc.) labeled with an interpretation 142 of a respective hand signal 104 and/or hand-held sign 104 in each sample image. Similarly, the training dataset 146 may include samples of other data types, such as videos, infrared images, point clouds, Radar data, etc., each labeled with a respective hand signal 104 and/or hand-held sign 104 indicated in a respective data sample. The hand signal detection machine learning module 140 may be trained, tested, and refined by the training dataset 146 and/or the sensor data 130. For example, in a training phase, the hand signal detection machine learning module 140 may be given some sample data 147 from the training dataset 146, without the respective labels, and asked to predict the interpretation of hand signal and/or hand-held sign indicated in each sample data 147. The hand signal detection machine learning module 140 may extract a set of features 148b from each sample data 147 and predict the interpretation of hand signal and/or hand-held sign indicated in each sample data 147 based on the extracted features 148b. In another example, in a testing phase, the hand signal detection machine learning module 140 may be given sensor data 130 (which are not labeled with hand signals 104 or hand-held signs 104) and asked to predict the interpretation of hand signal and/or hand-held sign indicated in each sensor data 130. The hand signal detection machine learning module 140 may extract a set of features 148a from each sensor data 130 and predict the interpretation of hand signal and/or hand-held sign indicated in each sensor data 130 based on the extracted features 148a. In a refining stage and backpropagation process, weight and bias values of neural networks of the hand signal detection machine learning module 140 may be updated to increase the prediction accuracy of the hand signal detection machine learning module 140. In this manner, the accuracy of predictions in detecting hand signals 104 and hand-held signs 104 and respective interpretations 142 is increased. In certain embodiments, supervised, semi-supervised, and/or unsupervised machine learning algorithms may be used to validate the predictions of the hand signal detection machine learning module 140 in detecting hand signals 104/hand-held signs 104 and respective interpretations 142 from sensor data 130.

The hand signal detection machine learning module 140 may determine that one or more pedestrians are altering traffic flow with hand signals or hand-held signs based on analysis of sensor data 130 from sensors 346. The hand signal detection machine learning module 140 can then use the determination to send instructions for appropriate alteration of the autonomous vehicle's trajectory to the planning module 462 (see FIG. 4). The one or more processors 122 execute the operations that allow the system to operate autonomous vehicle 302 in accordance with the applicable regulations for areas with a human (e.g., pedestrian, traffic officer, a crossing-guard, construction worker, law enforcement officer, or first responder) controlling traffic flow with hand signals or hand-held signs. The sensor data 130 captured by the sensors 346 is provided to control device 350 so that the determination of the use of hand signals or hand-held signs can be made. The control device 350 may determine what action should be taken by the autonomous vehicle 302 to operate according to the applicable (i.e., local) regulations. The sensor data 130 captured by the sensors 346 may be provided to the control device 350 so that the best course of action in light of the autonomous vehicle's status may be appropriately determined and performed.

### Oversight Server

Oversight server 160 may include one or more processing devices and is generally configured to oversee the operations of the autonomous vehicle 302 while they are in transit and oversee traveling of the autonomous vehicle 302. The oversight server 160 may also be configured to provide hardware and/or software resources to other components of the system 100. For example, the oversight server 160 may be configured to provide messages 172, 174, and/or a proposed trajectory 144, among other data/instructions to one or more autonomous vehicles 302.

The oversight server 160 may comprise a processor 162, a network interface 164, a user interface 166, and a memory 168. The components of the oversight server 160 are operably coupled to each other. The processor 162 may include one or more processing units that perform various functions of the oversight server 160. The memory 168 may store any data and/or instructions used by the processor 162 to perform its functions. For example, the memory 168 may store software instructions 170 that when executed by the processor 162 cause the oversight server 160 to perform one or more functions described herein. The oversight server 160 may be configured as shown or in any other suitable configuration.

In one embodiment, the oversight server 160 may be implemented by a cluster of computing devices that may serve to oversee the operations of the autonomous vehicle 302. For example, the oversight server 160 may be implemented by a plurality of computing devices using distributed computing and/or cloud computing systems. In another example, the oversight server 160 may be implemented by a plurality of computing devices in one or more data centers. As such, in certain embodiments, the oversight server 160 may include more processing power and/or resources than the control device 350. Thus, in certain embodiments, the operations of determining or confirming the hand signal/hand-held sign interpretation 142 may be performed by the oversight server 160. In certain embodiments, when the confidence score of the determination of the hand signal/hand-held sign interpretations 142 by the control device 350 becomes more than a threshold score, e.g., in response to increasing the accuracy in prediction of the hand signal/hand-held sign interpretations 142, the operations of determining or confirming the hand signal/hand-held sign interpretation 142 may be performed by the control device 350.

Processor 162 comprises one or more processors. The processor 162 may be any electronic circuitry, including state machines, one or more CPU chips, logic units, cores (e.g., a multi-core processor), FPGAs, ASICs, or DSPs. The processor 162 may be a programmable logic device, a microcontroller, a microprocessor, or any suitable combination of the preceding. The processor 162 may be communicatively coupled to and in signal communication with the network interface 164, user interface 166, and memory 168. The one or more processors are configured to process data and may be implemented in hardware or software. For example, the processor 162 may be 8-bit, 16-bit, 32-bit, 64-bit or of any other suitable architecture. The processor 162 may include an ALU (arithmetic-logic unit) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 170 to implement the functions disclosed herein, such as some or all of those described with respect to FIGS. 1-5. In some embodiments, the function described herein may be implemented using logic units, FPGAS, ASICs, DSPs, or any other suitable hardware or electronic circuitry. The processor 162 may be configured to perform one or more operations of the operational flow described in FIG. 1 and/or one or more operations of the method 200 described in FIG. 2.

Network interface 164 may be configured to enable wired and/or wireless communications of the oversight server 160. The network interface 164 may be configured to communicate data between the oversight server 160 and other devices, servers, autonomous vehicles 302, systems, or domains. For example, the network interface 164 may comprise an NFC interface, a Bluetooth interface, a Zigbee interface, a Z-wave interface, an RFID interface, a WIFI interface, a LAN interface, a WAN interface, a PAN interface, a modem, a switch, and/or a router. The processor 162 may be configured to send and receive data using the network interface 164. The network interface 164 may be configured to use any suitable type of communication protocol as would be appreciated by one of ordinary skill in the art.

User interfaces 166 may include one or more user interfaces that are configured to interact with users, such as the remote operator 184. The remote operator 184 may access the oversight server 160 via the communication path 186. In certain embodiments, the user interfaces 166 may include peripherals of the oversight server 160, such as monitors, keyboards, mouse, trackpads, touchpads, microphones, webcams, speakers, and the like. In certain embodiments, the user interface 166 may include a graphical user interface, a software application, or a web application. The remote operator 184 may use the user interfaces 166 to access the memory 168 to review any data stored in the memory 168. The remote operator 184 may confirm, update, and/or override the routing plan 136 and/or any other data stored in memory 168.

Memory 168 may be volatile or non-volatile and may comprise ROM, RAM, TCAM, DRAM, and SRAM. The memory 168 may include one or more of a local database, cloud database, NAS, etc. Memory 168 may store any of the information described in FIGS. 1-5 along with any other data, instructions, logic, rules, or code operable to implement the function(s) described herein when executed by processor 162. For example, the memory 168 may store software instructions 170, sensor data 130, object detection machine learning module 132, map data 134, routing plan 136, driving instructions 138, proposed trajectory 144, hand signal interpretation 142, messages 172, 174, and/or any other data/instructions. The software instructions 170 may include code that when executed by the processor 162 causes the oversight server 160 to perform one or more functions described herein, such as some or all of those described in FIGS. 1-5. The memory 168 comprises one or more disks, tape drives, or solid-state drives, and may be used as an over-flow data storage device, to store programs when such programs are selected for execution, and to store instructions and data that are read during program execution.

In certain embodiments, the navigating solutions such as routing plans 136 and proposed trajectories 144 may be implemented by Vehicle-to-Cloud-to-Human (V2C2H), Vehicle-to-Human (V2H), Vehicle-to-Cloud-to-Vehicle (V2C2V), Vehicle-to-Human-to-Vehicle (V2H2V), and/or Cloud-to-Cloud-to-Vehicle (C2C2V) communications, where human intervention is incorporated in determining navigating solutions for the autonomous vehicles 302. For example, the remote operator 184 may review the sensor data 130, the hand signal interpretation 142, and the proposed trajectory 144, and provide feedback as to whether the proposed trajectory 144 is the optimal navigation plan for the autonomous vehicle 302. The remote operator 184 may add a human perspective in determining the proposed trajectory 144 of the autonomous vehicles 302 that the control device 450 and/or the oversight server 160 otherwise do not provide. In some instances, the human perspective is preferable compared to machine's perspective in terms of safety, fuel-saving, etc. The control device 450 and the oversight server 160 learn from the feedback provided by the remote operator 184 and use the provided feedback as a training dataset to improve the accuracy of their prediction regarding the hand signal interpretation 142 and the proposed trajectory 144 for the autonomous vehicles 302.

In certain embodiments, the routing plans 136, updated routing plans 136, and/or indications of road conditions for the autonomous vehicles 302 may be implemented by any combination of V2V, V2C, V2C2H, V2H, V2C2V, V2H2V, C2C2V communications, among other types of communications.

### Application Server

The application server 180 may be any computing device configured to communicate with other devices, such as the oversight server 160, autonomous vehicles 302, databases, etc., via the network 110. The application server 180 may be configured to perform functions described herein and interact with the remote operator 184, e.g., via communication path 182 using its user interfaces. Examples of the application server 180 include, but are not limited to, desktop computers, laptop computers, servers, etc. In one example, the application server 180 may act as a presentation layer from which the remote operator 184 can access the oversight server 160. As such, the oversight server 160 may send the routing plan 136, sensor data 130, the proposed trajectory 144, hand signal interpretations 142, and messages 172, 174, and/or any other data/instructions to the application server 180, e.g., via the network 110. The remote operator 184, after establishing the communication path 182 with the application server 180, may review the received data and confirm, update, and/or override any of the proposed trajectory 144, hand signal interpretations 142, and messages 172, 174, for example.

The remote operator 184 may be an individual who is associated with and has access to the oversight server 160. For example, the remote operator 184 may be an administrator that can access and view the information regarding the autonomous vehicle 302, such as sensor data 130, driving instructions 138, routing plan 136, proposed trajectory 144, hand signal interpretations 142, and messages 172, 174, and other information that is available on the memory 168. In one example, the remote operator 184 may access the oversight server 160 from the application server 180 that is acting as a presentation layer via the network 110.

### Operational Flow for Navigating an Autonomous Vehicle in Response to Detecting a Hand Signal

In an example scenario, assume that the autonomous vehicle 302 is traveling on the road 102 and the autonomous vehicle 302 encounters a person 106 who is altering the traffic flow using hand signals 104 or hand-held signs 104. For brevity, hand-held sign 104 is not mentioned in the operations below. However, similar operations that are performed for a case when the person 106 is using hand signals 104 may be performed for a case when the person 106 is using hand-held signs 104. The person 106 may be a construction worker, a law enforcement officer, a traffic officer, a pedestrian, an emergency personnel, a driver or a passenger of a vehicle, a bicycle rider, a motorized bicycle rider, a motorcycle rider, and the like.

Examples of the hand signals 104 may include hands held up in a manner that indicates that traffic should stop, waving that indicates that traffic should commence and keep moving, hand motions that indicate a change in direction of traffic, and the like. Examples of hand-held signs 104 may include those with words such as “stop” and “slow”, or may include lighted devices, particularly at night. Lighted devices may include lighted wands or flashlights (i.e., torches) of various colors (e.g., white, yellow, orange) to indicate a change in traffic flow. Flags may also be used and considered as an alternative implement when discussing hand-held signs. Flags may include colored flags to direct the flow of traffic or patterned flags to indicate road conditions, such a closed road. In some instances, the hand signals may originate from a driver of another vehicle or a bicycle, used in lieu of or in addition to lighted signals.

The operational flow of the system 100 may begin when the autonomous vehicle 302 encounters the person 106 who is altering the traffic flow using hand signals 104 (or hand-held sign 104). While traveling on the road 102, the sensors 346 may capture sensor data 130 and communicate the sensor data 130 to the control device 350. The sensor data 130 may provide information about the road 102 ahead of the autonomous vehicle 302, such as objects, road signs, road markings, etc.

### Detecting a Hand Signal Used for Altering the Traffic

The control device 350 receives the sensor data 130. The control device 350 may use the sensor data 130 to navigate the autonomous vehicle 302 autonomously. In certain embodiments, the control device 350 may be configured to determine the interpretation 142 of the hand signal 104. In certain embodiments, the interpretation 142 of the hand signal 104 may be determined by the oversight server 160. For example, the control device 350 may transmit the sensor data 130 along with a query message to provide the interpretation 142 of the hand signal 104 to the oversight server 160. The corresponding description below describes the embodiment where the interpretation 142 of the hand signal 104 is determined by the control device 350. The embodiment where the interpretation 142 of the hand signal 104 is determined and/or confirmed by the oversight server 160 is described further below.

The control device 350 may analyze the sensor data 130 by feeding the sensor data 130 to the hand signal detection machine learning module 140. In analyzing the sensor data 130, the control device 350 may determine that the sensor data 130 comprises an indication of the person 106 altering the traffic flow using the hand signal 104. The control device 350 may determine the interpretation 142 of the hand signal 104. In this process, the control device 350 may feed the sensor data 130 to the object detection machine learning module 132 and/or the hand signal detection machine learning module 140 to detect objects on the road 102 and determine whether a hand signal 104 (and/or a hand-held sign 104) is being used to direct traffic. For example, the objects may include the person 106, flag held by the person 106, hand gestures performed by the person 106, hand signals 104 indicated by the person 106, traffic sign, and hand-held sign, among other objects.

The control device 350 may access the training dataset 146 comprising a plurality of data samples, such as images, videos, LiDAR data, Radar data, point cloud data, and any other data format. The description below describes using images of the training dataset 146. However, it is understood that any number and any combination of sample data formats may be used in determining the interpretation of the hand signal 104. Each of the sample data in the training dataset 146 may be labeled with a respective hand signal 104. For example, with respect to the images in the training dataset 146, each respective image is labeled with an interpretation of a hand signal shown in the respective image. The control device 350 extracts a first set of features 148a from the sensor data 130 where the hand signal 104 is detected (e.g., by the object detection machine learning module 132 and/or the hand signal detection machine learning module 140). The first set of features 148a indicates a type of the hand signal 104. For example, the type of the hand signal 104 may be slow down, pull over, stop, change lane to right, change lane to left, or any suitable hand signal that may be used to direct traffic. The first set of features 148a may also indicate that the person 106 is altering the traffic flow using the hand signal 104. The first set of features 148a may be represented by a first feature vector 150a comprising a first set of numerical values. The control device 350 may select a data sample 147 from the training dataset 146 for evaluation. The control device 350 may iteratively select a data sample 147 from the training dataset 146 until no data sample 147 is left for evaluation. For example, with respect to an image selected from among images in the training dataset 146, the control device 350 may extract a second set of features 148b from the selected image. The image may show a distinct hand signal. The image may be labeled with a particular interpretation of the distinct hand signal shown in the image. The second set of features 148b may indicate a category of the distinct hand signal, where the category of the distinct hand signal may be slow down, pull over, stop, change lane to right, change lane to left, or any suitable hand signal that may be used to direct traffic. The second set of features 148b may be represented by a second feature vector 150b comprising a second set of numerical values. The control device 350 may determine a distance between the first feature vector 150a and the second feature vector 150b. For example, the control device 350 may determine the Euclidian distance between the first feature vector 150a and the second feature vector 150b. In response to determining that the distance (e.g., Euclidian distance) between the first feature vector 150a and the second feature vector 150b is less than a threshold distance (e.g., less than 2%, 1%, etc. or less than 0.1, 0.01, etc.), the control device 350 may determine that the interpretation of the hand signal (detected from the sensor data 130) corresponds to the particular interpretation of the distinct hand signal (shown in the image from the training dataset 146). Otherwise, the control device 350 may determine that the interpretation of the hand signal (detected from the sensor data 130) does not correspond to the particular interpretation of the distinct hand signal (shown in the image from the training dataset 146).

In the same or another example, the control device 350 may determine a cosine similarity score between the first feature vector 150a and the second feature vector 150b. The cosine similarity score between the first feature vector 150a and the second feature vector 150b may correspond to their dot product divided by the product of their magnitudes. If it is determined that the cosine similarity score between the first feature vector 150a and the second feature vector 150b is within a threshold range from the integer one (e.g., within 0). 1 range from 1), it may be determined that the interpretation of the hand signal (detected from the sensor data 130) corresponds to the particular interpretation of the distinct hand signal (shown in the image from the training dataset 146). Otherwise, the control device 350 may determine that the interpretation of the hand signal (detected from the sensor data 130) does not correspond to the particular interpretation of the distinct hand signal (shown in the image from the training dataset 146). The control device 350) may perform similar operations to extract features 148b from each other image (and other data samples 147) in the training dataset 146 to determine if the hand signal 104 indicated in the sensor data 130 corresponds to a hand signal 104 shown in a data sample 147. Similarly, if a hand-held sign 104 was used by the person 106, the control device 350 may perform similar operations to determine the interpretation of the hand-held sign 104.

The control device 350 may determine a pose 108 associated with the person 106. In this process, in certain embodiments, the control device 350 may use the hand signal detection machine learning module 140 to determine the pose associated with the person 106. For example, the hand signal detection machine learning module 140 may include neural network-based pose estimation algorithms configured, trained, tested, and refined to determine a pose of a person. The control device 350 may feed the sensor data 130 to the neural network-based pose estimation algorithm. The output of the neural network-based pose estimation algorithm may include an embedding vector of numerical values. The numerical values of the output vector may represent coordinates of a simplified “stick figure” or “skeleton” showing and connecting the location coordinates of a head, arms, hands, torso, hip, legs, and feet of the observed person 106 on a display screen. For example, based on the output vector of the neural network-based pose estimation algorithm, the control device 350 may determine whether the person 106 is standing, sitting, on a bicycle, in a vehicle, walking across the road 102, facing oncoming traffic, facing away from the coming traffic, facing toward the road 102, facing away from the road 102, or is taking any other pose.

The control device 350 may determine that the hand signal 104 is in use to alter the traffic flow based on the determined interpretation 142 of the hand signal 104 and the pose 108 associated with the person 106. For example, if it is determined that the hand signal interpretation 142 is related to traffic movement or directing traffic, the control device 350 may determine that the hand signal 104 is in use to alter the traffic flow. The hand signal interpretation 142 related to traffic movement or directing traffic may include turning right, turning left, moving forward, stopping, reducing speed, avoiding a construction zone, slowing down in a school zone, yielding to a particular lane, commencing forward, yielding to a part of an intersection, among others. In the same or another example, if it is determined that the pose 108 associated with the person 106 indicates that the person 106 is facing the oncoming traffic along the road 102, the control device 350 may determine that the hand signal 104 is in use to alter the traffic flow. In the same or another example, if it is determined that the person 106 is on a traffic lane or beside a traffic lane, the control device 350 may determine that the hand signal 104 is in use to alter the traffic flow. In the same or another example, if it is determined that the person 106 is waving a flag, a baton, or other devices to direct traffic, the control device 350 may determine that the hand-held sign 104 is in use to alter the traffic flow. In the same or another example, if it is determined that the person 106 is holding a sign with symbols and/or text that indicates directing the traffic in a particular manner, the control device 350 may determine that the hand-held sign 104 is in use to alter the traffic flow.

In some embodiments, the interpretation 142 of the hand signal 104 may be determined by the oversight server 160, similar to that described above with respect to the control device 350. For example, the control device 350 may transmit the sensor data 130 along with a query message 148 to provide and/or verify the interpretation 142 of the hand signal 104 to the oversight server 160. The oversight server 160 may employ cloud-based hand signal detection machine learning module 140 to determine and verify the interpretation 142 of the hand signal 104.

In some embodiments, the determination of the interpretation 142 of the hand signal 104 may be performed by the oversight server 160 initially, and after the confidence score of the prediction of the hand signal detection machine learning module 140 is increased to be more than a threshold confidence score, the intelligence obtained from training the hand signal detection machine learning module 140 may be implemented on to the control device 350 using edge computing.

### Verifying the Hand Signal Interpretation

In certain embodiments, to verify the hand signal interpretation 142, the control device 350 may communicate the sensor data 130, the determined interpretation 142 of the detected hand signal 104 along with a query message 148 to the oversight server 160. The query message 148 may request to verify the determined interpretation 142 of the hand signal 104. The oversight server 160 may analyze the sensor data 130 using the cloud-based hand signal detection machine learning module 140 to determine the interpretation 142 of the hand signal 104 indicated in the sensor data 130, similar to that described above with respect to the operations of control device 350.

In some embodiments, if the oversight server 160 determines that the interpretation 142 of the hand signal 104 that the control device 350 has determined is correct, the oversight server 106 may verify and confirm the determined interpretation 142 of the hand signal 104. In this case, the oversight server 160 may communicate a message 172 to the control device 350, where the message 172 may indicate that the determined interpretation 142 of the hand signal 104 is verified.

In some embodiments, if the oversight server 160 determines that the interpretation 142 of the hand signal 104 that the control device 350 has determined is incorrect, the oversight server 106 may update or override the determined interpretation 142 of the hand signal 104. In this case, the oversight server 160 may communicate a message 172 to the control device 350, where the message 172 may indicate that the determined interpretation 142 of the hand signal 104 is not verified. In this case, the oversight server 160 may include the updated or verified interpretation 142 of the hand signal 104 in the message 172.

In some embodiments, the remote operator 184 may evaluate the determination of the control device 350 and the oversight server 160, and update, confirm, or override the determined interpretation 142 of the hand signal 104 by either of control device 350 and/or oversight server 160. The feedback of the remote operator 184 may be used to improve the accuracy of the prediction of the control device 350 and oversight server 160.

### Determining a Proposed Trajectory According to the Hand Signal

In response to receiving the message 172, the control device 350 may determine a proposed trajectory 144 for the autonomous vehicle 302 according to the interpretation 142 of the detected hand signal 104. The determined proposed trajectory 144 may follow the interpretation 142 of the detected hand signal 104. For example, if the interpretation 142 of the hand signal 104 is stop, the proposed trajectory 144 is stopping the autonomous vehicle 302. Similarly, in other examples, for any interpretation 142 of the hand signal 104, the proposed trajectory 144 may follow the interpretation 142 of the hand signal 104, including turning right, turning left, moving forward, reducing speed, avoiding a construction zone, slowing down in a school zone, yielding to a particular lane, commencing forward, yielding to a part of an intersection, among others.

Other interpretations of hand signals 104 and respective proposed trajectories 144 are also contemplated, such as pull over, change lane, changing lane while staying on a predetermined route, etc. The control device 350 may implement the proposed trajectory 144 by updating the routing plan 136. For example, the control device 350 may implement the proposed trajectory 144 by updating the turn-by-turn navigation of the autonomous vehicle 302. The course of action to be taken may include slowing, stopping, moving into a shoulder, changing route, changing lane while staying on the same general route, and the like.

In some embodiments, the control device 350 may request the oversight server 160 to verify the proposed trajectory 144. In this process, the control device 350 may communicate the proposed trajectory 144 along with a query message 150 to the oversight server 160, where the query message 150 may request to verify the proposed trajectory 144. The oversight server 160 may evaluate the proposed trajectory 144 based on the interpretation 142 of the hand signal 104. If the oversight server 160 determines that the proposed trajectory 144 follows the confirmed interpretation 142 of the hand signal 104, the oversight server 160 may confirm the proposed trajectory 144. In response, the oversight server 160) may communicate a message 174 that indicates the proposed trajectory 144 is confirmed to the control device 350. If the oversight server 160) determines that the proposed trajectory 144 does not follow the confirmed interpretation 142 of the hand signal 104, the oversight server 160 may update the proposed trajectory 144 according to the confirmed interpretation 142 of the hand signal 104. In response, the oversight server 160 may update the proposed trajectory 144 and communicate a message 174 that includes the updated proposed trajectory 144 to the control device 350.

In some embodiments, the remote operator 184 may evaluate the proposed trajectory 144, and update, confirm, or override the proposed trajectory 144 determined by either of control device 350 and/or oversight server 160. The feedback of the remote operator 184 may be used to improve the accuracy of the operations of the control device 350 and oversight server 160.

### Navigating the Autonomous Vehicle According to the Proposed Trajectory

To navigate the autonomous vehicle 302, the control device 350 may determine whether any obstruction 107 prevents navigating the autonomous vehicle 302 according to the proposed trajectory 144. In other words, the control device 350 may evaluate whether navigating the autonomous vehicle 302 according to the proposed trajectory 144 is safe for the autonomous vehicle, surrounding vehicles, and pedestrians. In this process, the control device 350 may analyze the sensor data 130 via the object detection machine learning modules 132 and determine whether the sensor data 130 includes an indication of an obstruction 107. The obstruction 107 may be a vehicle, a pedestrian, an animal, debris, or any other object.

If it is determined that no obstruction 107 is present that prevents navigating the autonomous vehicle 302 according to the proposed trajectory 144, the control device 350) may navigate the autonomous vehicle 302 according to the proposed trajectory 144. For example, the control device 350 may execute the operations that allow the system to operate autonomous vehicle 302 in accordance with the applicable regulations for areas with person 106 (e.g., pedestrian, traffic officer, a crossing-guard, construction worker, law enforcement officer, or first responder) controlling traffic flow with hand signals or hand-held signs.

In certain embodiments, if it is determined that an obstruction 107 is detected that prevents navigating the autonomous vehicle 302 according to the proposed trajectory 144, the control device 350 may stop the autonomous vehicle 302, wait until the sensor data 130 indicates that the obstruction 107 is no longer present, and navigate the autonomous vehicle 302 according to the proposed trajectory 144.

In certain embodiments, if it is determined that an obstruction 107 is detected that prevents navigating the autonomous vehicle 302 according to the proposed trajectory 144, the control device 350) may determine a second proposed trajectory 144 that includes a traveling path that still follows the interpretation 142 of the hand signal 104 but avoids the obstruction 107.

In certain embodiments, if it is determined that an obstruction 107 is detected that prevents navigating the autonomous vehicle 302 according to the proposed trajectory 144, the control device 350 may perform a minimal risk maneuver (MRC) operation. Examples of the MRC operation may include stopping the autonomous vehicle 302 without hindering the traffic and pulling over the autonomous vehicle 302 to a side of the road 102.

### Prioritizing the Analysis for Hand Signal Detection (or Hand-Held Sign Detection)

In certain embodiments, the control device 350 may prioritize analyzing the sensor data 130 for hand signal detection (or hand-held sign detection) in particular geographical areas 111 where it is known that hand signals 104 are used to control or alter traffic. In this process, the control device 350 may access the map data 134 that includes the virtual map of a road 102 traveled by the autonomous vehicle 302. The control device 350 may determine the location of the autonomous vehicle 302, e.g., by the global positioning sensor (346g in FIG. 3). Based on the location of the autonomous vehicle 302 and the map data 134, the control device 350 may determine that the autonomous vehicle 302 is traveling toward (or within) a particular area 111 where it is known that hand signals are used to control or alter traffic.

Examples of the particular area 111 may include a school road crossing area, a construction area, an intersection, a road accident area, or any other location where it is known that hand signals may be used to control or alter traffic. In the example scenario described above when the hand signal 104 is encountered, the sensor data 130 may be captured when the autonomous vehicle 302 is traveling within the particular area 111. In response, the control device 350 may prioritize the analysis of the sensor data 130 for hand signal detection. For example, the control device 350) may assign a higher weight value to the hand signal detection machine learning module 140 compared to other object detection algorithms.

In certain embodiments, the control device 350 may prioritize the analysis of the sensor data 130 based on a time window 152 when the sensor data 130 is captured. For example, the control device 350) may determine that the autonomous vehicle 302 is traveling within the particular area 111 during a particular time window 152, such as active hours of a construction site, school opening hours, or school closing hours. The control device 350 may prioritize the analysis of the sensor data 130 for hand signal detection (or hand-held sign detection) in such time windows 152 when the sensor data 130 is captured over other sensor data 130 captured in other time windows.

In certain embodiments, the control device 350 may be configured to differentiate between when an authorized person 106, such as a construction worker, a law enforcement officer, emergency personnel is performing the hand signal 104 from a bad actor who is attempting to tamper with the autonomous vehicle 302 by performing the hand signal 104 (or hand-held sign 104). For example, the control device 350 may implement a machine learning algorithm that is pre-trained to differentiate between when an authorized person 106 is performing the hand signal 104 (or hand-held sign 104) to alter the traffic and a bad actor attempting to tamper with the autonomous vehicle 302 by performing the hand signal 104 (or hand-held sign 104). For example, the control device 350 may determine that the person 106 is an authorized person if it is determined that the person 106 is wearing a particular uniform, such as construction uniform, a law enforcement uniform, a paramedic uniform, an emergency personnel uniform, and the like and the hand signal 104 is used in an example area 111.

In certain embodiments, the control device 350 may be configured to discern that a driver of a vehicle, a passenger of a vehicle, a bicycle rider, or a rider of a motorized bicycle or a motorcycle is signaling the autonomous vehicle 302 to pass by, for example, using hand signals 104. If the control device 350 determines that the driver of a vehicle, a passenger of a vehicle, a bicycle rider, a rider of a motorized bicycle, or a rider of a motorcycle is not a bad actor attempting to tamper with the autonomous vehicle 302, the control device 350 may treat the driver of a vehicle, a bicycle rider, a rider of a motorized bicycle, or a rider of a motorcycle as an authorized person 106. Similarly, the control device 350 may determine that a hand-held sign 104 is in use to alter the traffic if the person 106 is facing oncoming traffic and holding the hand-held sign 104.

In certain embodiments, the control device 350 may transmit the proposed trajectory 144 and/or the hand signal interpretation 142 that is/are decided and finalized to one or more other autonomous vehicles 302, e.g., that are heading toward the location of the person 106 that is performing the hand signal 104 (or the hand-held sign 104) and that are within a threshold distance from the person 106 (or the autonomous vehicle 302), such as within a hundred feet, two hundred feet, or any other suitable distance. The one or more other autonomous vehicles 302 may be navigated (by their respective control devices 350) according to the proposed trajectory 144 upon determining that the person 106 is still directing the traffic using the hand signal 104.

In certain embodiments, the oversight server 160 may transmit the proposed trajectory 144 and/or the hand signal interpretation 142 that is/are decided and finalized to one or more other autonomous vehicles 302, e.g., that are heading toward the location of the person 106 that is performing the hand signal 104 (or the hand-held sign 104) and that are within the threshold distance from the person 106 (or the lead autonomous vehicle 302), such as within a hundred feet, two hundred feet, or any other suitable distance. The one or more other autonomous vehicles 302 may be navigated (by their respective control devices 350) according to the proposed trajectory 144 upon determining that the person 106 is still directing the traffic using the hand signal 104.

In certain embodiments, the oversight server 160 may communicate the sensor data 130, the proposed trajectory 144, and/or the hand signal interpretation 142 to a third party whose load the autonomous vehicle 302 is transporting to a particular destination. The third party may review the received data and provide input as to what driving and traveling parameters to be prioritized. The oversight server 160 may receive the input from the third party regarding one or more driving and traveling parameters to prioritize, such as a speed, a fuel-saving parameter, or maintaining an originally planned route (e.g., the routing plan 136). The oversight server 160 may update the proposed trajectory 144 based on the received input and transmit the updated trajectory 144 to the control device 350 for the autonomous vehicle navigation. The control device 350 may navigate the autonomous vehicle accordingly.

### Example Method for Navigation According to a Hand Signal (or a Hand-Held Sign)

FIG. 2 illustrates an example flowchart of a method 200 for autonomous vehicle navigation according to a hand signal 104 (or hand-held sign 104). Modifications, additions, or omissions may be made to method 200. Method 200 may include more, fewer, or other operations. For example, operations may be performed in parallel or in any suitable order. While at times discussed as the system 100, autonomous vehicle 302, control device 350, oversight server 160, or components of any of thereof performing operations, any suitable system or components of the system may perform one or more operations of the method 200. For example, one or more operations of method 200 may be implemented, at least in part, in the form of software instructions 128, software instructions 170, and processing instructions 380, respectively, from FIGS. 1 and 3, stored on non-transitory, tangible, machine-readable media (e.g., memory 126, memory 168, and data storage 390, respectively, from FIGS. 1 and 3) that when run by one or more processors (e.g., processors 122, 162, and 370, respectively, from FIGS. 1 and 3) may cause the one or more processors to perform operations 202-222.

At operation 202, the control device 350 accesses the sensor data 130 that provides information about a road 102 ahead of the autonomous vehicle 302. For example, the sensor data 130 may include indications of objects, such as vehicles, road signs, pedestrians, etc. and their locations.

At operation 204, the control device 350 determines that the sensor data 130 comprises an indication of a person 106 altering the traffic flow using a hand signal 104. In this process, the control device 350 may feed the sensor data 130 to the object detection machine learning module 132 to detect the person 106 signaling the traffic flow using the hand signal 104.

At operation 206, the control device 350 may determine the interpretation 142 of the hand signal 104. In this process, the control device 350 may feed the sensor data 130 to the hand signal detection machine learning module 140 to predict the hand signal interpretation 142, similar to that described in FIG. 1.

At operation 208, the control device 350 determines a pose 108 associated with the person 106. In this process, the control device 350 may feed the sensor data 130 to the neural network-based pose estimation algorithm to determine the pose 108 of the person 106, similar to that described in FIG. 1.

At operation 210, the control device 350 may determine whether the hand signal 104 is in use to alter the traffic flow based on the hand signal interpretation 142 and the pose 108 of the person 106. The control device 350 may determine that the hand signal 104 is in use to alter the traffic flow based on one or more indications detected from the sensor data 130. For example, the control device 350 may determine that the hand signal 104 is in use to alter the traffic if the person 106 is facing oncoming traffic and performing the hand signal 104, and that the person 106 is wearing a construction uniform, a law enforcement uniform, a paramedic uniform, an emergency personnel uniform, and the like. In the same or another example, the control device 350 may determine that the hand signal 104 is in use to alter the traffic if it is determined that the person 106 is an authorized person (such as a law enforcement personnel, emergency personnel, a construction worker, a school zone crosswalk safety personnel, a crossing guard, and the like) as identified by their uniforms (e.g., via uniform recognition), identity (e.g., via facial recognition and comprising the identity against an external database), credentials (e.g., via identification card verification). The control device 350 may also determine that the person 106 is on a traffic lane or in a middle (or near the middle) of an intersection. The location of the person 106 may be another indication that can be used to determine if the hand signal 104 is in use to alter the traffic flow.

The control device 350 may also determine if the person 106 is near a construction zone or a road anomaly, such as a road closure, a road accident, and the like. For example, the control device 350 may determine if the person 106 (and/or the autonomous vehicle 302) in an area 111 that it is known where hand signals 104 (or hand-held signs 104) are used to direct traffic, e.g., a construction zone, a road closure, a school zone, an area near a road accident, congested traffic, any other road anomaly, etc. The control device 350 may use this information as indications that the hand signal 104 may be in use to direct traffic.

The control device 350 may assign a weight value to each indication of the location of the person 106 (e.g., inside an intersection, on a traffic lane, etc.), the area where the hand signal 104 is used (e.g., in a school zone, near a construction zone, near a road accident, etc.), whether the person 106 is determined to be an authorized person to direct traffic (e.g., based on their uniform), whether the pose of the person 106 indicates that the person 106 is facing oncoming traffic, whether the hand signal interpretation 142 is related to traffic flow. If it is determined that an indication data indicates that the hand signal is in use to direct traffic, the control device 350 may assign a high weight value to the indication data (e.g., 8 or 9 out of 10). Otherwise, the control device 350 may assign a low weight value to the indication data (e.g., 2 or 3 out of 10). The control device 350 may determine a weighted sum of the indication data and the weight values. If the weighted sum is determined to be more than a threshold percentage (e.g., more than 90%, 95%, etc.), the control device 350 may determine that the hand signal is in use to direct the traffic flow. Otherwise, the control device 350 may determine that the hand signal is not in use to direct the traffic flow: Similar operations apply for cases where hand-held signs 104 are used. If it is determined that the hand signal 104 is in use to alter the traffic flow, method 200 may proceed to operation 212. Otherwise, method 200 may return to operation 202.

At operation 212, the control device 350 may communicate the sensor data 130, the hand signal interpretation 142, and a first query message 148 to the oversight server 160, where the first query message 148 requests to verify the hand signal interpretation 142. The oversight server 160 may feed the sensor data 130 to the cloud computing-based hand signal detection machine learning module 140 in order to determine the hand signal interpretation 142. In certain embodiments, the oversight server 160 may update, confirm, or override the determination of the control device 350 regarding the hand signal interpretation 142. In certain embodiments, the remote operator 184 may review the sensor data 130 and update, confirm, or override the determination of the control device 350 and/or the oversight server 160. The final interpretation 142 of the hand signal 104 is used to further increase the accuracy of the prediction process of the hand signal detection machine learning module 140.

At operation 214, the control device 350 may receive the first message 172 that indicates the hand signal interpretation 142 is verified. This operation may be in response to the oversight server 160 evaluating the sensor data 130 using cloud computing-based hand signal detection machine learning module 140 and determining that the hand signal interpretation 142 is correct, similar to that described in FIG. 1. In other cases, the oversight server 160 and/or the remote operator 184 may update, confirm, or override the determination of the control device 350 and provide the finalized interpretation 142 of the hand signal 104 to the control device 350.

At operation 216, the control device 350 may determine a proposed trajectory 144 for the autonomous vehicle 302 according to the finalized hand signal interpretation 142. The proposed trajectory 144 may follow the hand signal interpretation 142, similar to that described in FIG. 1. The finalized hand signal interpretation 142 may be the finalized interpretation 142 according to the oversight server 160 and/or the remote operator 184. In certain embodiments, the control device 350 may communicate the determined proposed trajectory 144 to the oversight server 160 along with a query message requesting to confirm the proposed trajectory 144, similar to that described in FIG. 1. The oversight server 160 and/or the remote operator 184 may update, confirm, or override the proposed trajectory 144 determined by the control device 350, for example, based on additional information that may not be available to the control device 350, including road conditions, weather conditions, traffic conditions further ahead of the autonomous vehicle 302, input from a third party whose load the autonomous vehicle 302 is carrying to reduce travel time, travel milage, fuel saving parameter, among others.

At operation 218, the control device 350 determines whether an obstruction 107 that prevents navigating the autonomous vehicle 302 according to the proposed trajectory 144 is detected, for example, by analyzing the sensor data 130 and determining whether the sensor data 130 includes an indication of the obstruction 107, similar to that described in FIG. 1. If it is determined that the obstruction 107 that prevents navigating the autonomous vehicle 302 according to the proposed trajectory 144 is detected, method 200 may proceed to operation 220. Otherwise, the method 200 may proceed to operation 222.

At operation 220, the control device 350 may stop the autonomous vehicle 302 and wait until the obstruction 107 is cleared from the traveling path of the autonomous vehicle 302 according to the proposed trajectory 144. In certain embodiments, if the obstruction 107 is not cleared within a threshold time period (e.g., within ten minutes, fifteen minutes, etc.), the control device 350 may communicate a message to the oversight server 160 requesting for further navigation instructions. In certain embodiments, if the obstruction 107 is not cleared within a threshold time period (e.g., within ten minutes, fifteen minutes, etc.), the control device 350 may perform an MRC operation, such as pulling over. At operation 222, the control device 350 may navigate the autonomous vehicle 302 according to the proposed trajectory 144.

### Example Autonomous Vehicle and its Operation

FIG. 3 shows a block diagram of an example vehicle ecosystem 300 in which autonomous driving operations can be determined. As shown in FIG. 3, the autonomous vehicle 302 may be a semi-trailer truck. The vehicle ecosystem 300 may include several systems and components that can generate and/or deliver one or more sources of information/data and related services to the in-vehicle control computer 350 that may be located in an autonomous vehicle 302. The in-vehicle control computer 350 can be in data communication with a plurality of vehicle subsystems 340, all of which can be resident in the autonomous vehicle 302. A vehicle subsystem interface 360 may be provided to facilitate data communication between the in-vehicle control computer 350 and the plurality of vehicle subsystems 340. In some embodiments, the vehicle subsystem interface 360 can include a controller area network (CAN) controller to communicate with devices in the vehicle subsystems 340.

The autonomous vehicle 302 may include various vehicle subsystems that support the operation of the autonomous vehicle 302. The vehicle subsystems 340 may include a vehicle drive subsystem 342, a vehicle sensor subsystem 344, a vehicle control subsystem 348, and/or network communication subsystem 392. The components or devices of the vehicle drive subsystem 342, the vehicle sensor subsystem 344, and the vehicle control subsystem 348 shown in FIG. 3 are examples. The autonomous vehicle 302 may be configured as shown or any other configurations.

The vehicle drive subsystem 342 may include components operable to provide powered motion for the autonomous vehicle 302. In an example embodiment, the vehicle drive subsystem 342 may include an engine/motor 342a, wheels/tires 342b, a transmission 342c, an electrical subsystem 342d, and a power source 342e.

The vehicle sensor subsystem 344 may include a number of sensors 346 configured to sense information about an environment or condition of the autonomous vehicle 302. The vehicle sensor subsystem 344 may include one or more cameras 346a or image capture devices, a radar unit 346b, one or more thermal sensors 346c, a wireless communication unit 346d (e.g., a cellular communication transceiver), an inertial measurement unit (IMU) 346e, a laser range finder/LiDAR unit 346f, a Global Positioning System (GPS) transceiver 346g, a wiper control system 346h. The vehicle sensor subsystem 344 may also include sensors configured to monitor internal systems of the autonomous vehicle 302 (e.g., an 02 monitor, a fuel gauge, an engine oil temperature, etc.).

The IMU 346e may include any combination of sensors (e.g., accelerometers and gyroscopes) configured to sense position and orientation changes of the autonomous vehicle 302 based on inertial acceleration. The GPS transceiver 346g may be any sensor configured to estimate a geographic location of the autonomous vehicle 302. For this purpose, the GPS transceiver 346g may include a receiver/transmitter operable to provide information regarding the position of the autonomous vehicle 302 with respect to the Earth. The radar unit 346b may represent a system that utilizes radio signals to sense objects within the local environment of the autonomous vehicle 302. In some embodiments, in addition to sensing the objects, the radar unit 346b may additionally be configured to sense the speed and the heading of the objects proximate to the autonomous vehicle 302. The laser range finder or LiDAR unit 346f may be any sensor configured to use lasers to sense objects in the environment in which the autonomous vehicle 302 is located. The cameras 346a may include one or more devices configured to capture a plurality of images of the environment of the autonomous vehicle 302. The cameras 346a may be still image cameras or motion video cameras.

Cameras 346a may be rear-facing and front-facing so that pedestrians, and any hand signals made by them or signs held by pedestrians, may be observed from all around the autonomous vehicle. These cameras 346a may include video cameras, cameras with filters for specific wavelengths, as well as any other cameras suitable to detect hand signals, hand-held traffic signs, or both hand signals and hand-held traffic signs. A sound detection array, such as a microphone or array of microphones, may be included in the vehicle sensor subsystem 344. The microphones of the sound detection array may be configured to receive audio indications of the presence of, or instructions from, authorities, including sirens and commands such as “Pull over.” These microphones are mounted, or located, on the external portion of the vehicle, specifically on the outside of the tractor portion of an autonomous vehicle. Microphones used may be any suitable type, mounted such that they are effective both when the autonomous vehicle is at rest, as well as when it is moving at normal driving speeds.

The vehicle control subsystem 348 may be configured to control the operation of the autonomous vehicle 302 and its components. Accordingly, the vehicle control subsystem 348 may include various elements such as a throttle and gear selector 348a, a brake unit 348b, a navigation unit 348c, a steering system 348d, and/or an autonomous control unit 348e. The throttle and gear selector 348a may be configured to control, for instance, the operating speed of the engine and, in turn, control the speed of the autonomous vehicle 302. The throttle and gear selector 348a may be configured to control the gear selection of the transmission. The brake unit 348b can include any combination of mechanisms configured to decelerate the autonomous vehicle 302. The brake unit 348b can slow the autonomous vehicle 302 in a standard manner, including by using friction to slow the wheels or engine braking. The brake unit 348b may include an anti-lock brake system (ABS) that can prevent the brakes from locking up when the brakes are applied. The navigation unit 348c may be any system configured to determine a driving path or route for the autonomous vehicle 302. The navigation unit 348c may additionally be configured to update the driving path dynamically while the autonomous vehicle 302 is in operation. In some embodiments, the navigation unit 348c may be configured to incorporate data from the GPS transceiver 346g and one or more predetermined maps so as to determine the driving path for the autonomous vehicle 302. The steering system 348d may represent any combination of mechanisms that may be operable to adjust the heading of autonomous vehicle 302 in an autonomous mode or in a driver-controlled mode.

The autonomous control unit 348e may represent a control system configured to identify, evaluate, and avoid or otherwise negotiate potential obstacles or obstructions in the environment of the autonomous vehicle 302. In general, the autonomous control unit 348e may be configured to control the autonomous vehicle 302 for operation without a driver or to provide driver assistance in controlling the autonomous vehicle 302. In some embodiments, the autonomous control unit 348e may be configured to incorporate data from the GPS transceiver 346g, the radar unit 346b, the LiDAR unit 346f, the cameras 346a, and/or other vehicle subsystems to determine the driving path or trajectory for the autonomous vehicle 302.

The network communication subsystem 392 may comprise network interfaces, such as routers, switches, modems, and/or the like. The network communication subsystem 392 may be configured to establish communication between the autonomous vehicle 302 and other systems, servers, etc. The network communication subsystem 392 may be further configured to send and receive data from and to other systems.

Many or all of the functions of the autonomous vehicle 302 can be controlled by the in-vehicle control computer 350. The in-vehicle control computer 350 may include at least one data processor 370 (which can include at least one microprocessor) that executes processing instructions 380 stored in a non-transitory computer-readable medium, such as the data storage device 390 or memory. The in-vehicle control computer 350 may also represent a plurality of computing devices that may serve to control individual components or subsystems of the autonomous vehicle 302 in a distributed fashion. In some embodiments, the data storage device 390 may contain processing instructions 380 (e.g., program logic) executable by the data processor 370 to perform various methods and/or functions of the autonomous vehicle 302, including those described with respect to FIGS. 1-6.

The data storage device 390 may contain additional instructions as well, including instructions to transmit data to, receive data from, interact with, or control one or more of the vehicle drive subsystem 342, the vehicle sensor subsystem 344, and the vehicle control subsystem 348. The in-vehicle control computer 350 can be configured to include a data processor 370 and a data storage device 390. The in-vehicle control computer 350 may control the function of the autonomous vehicle 302 based on inputs received from various vehicle subsystems (e.g., the vehicle drive subsystem 342, the vehicle sensor subsystem 344, and the vehicle control subsystem 348).

FIG. 4 shows an exemplary system 400 for providing precise autonomous driving operations. The system 400 may include several modules that can operate in the in-vehicle control computer 350, as described in FIG. 3. The in-vehicle control computer 350 may include a sensor fusion module 402 shown in the top left corner of FIG. 4, where the sensor fusion module 402 may perform at least four image or signal processing operations. The sensor fusion module 402 can obtain images from cameras located on an autonomous vehicle to perform image segmentation 404 to detect the presence of moving objects (e.g., other vehicles, pedestrians, etc.,) and/or static obstacles (e.g., stop sign, speed bump, terrain, etc.,) located around the autonomous vehicle. The sensor fusion module 402 can obtain LiDAR point cloud data item from LiDAR sensors located on the autonomous vehicle to perform LiDAR segmentation 406 to detect the presence of objects and/or obstacles located around the autonomous vehicle.

The sensor fusion module 402 can perform instance segmentation 408 on image and/or point cloud data items to identify an outline (e.g., boxes) around the objects and/or obstacles located around the autonomous vehicle. The sensor fusion module 402 can perform temporal fusion 410 where objects and/or obstacles from one image and/or one frame of point cloud data item are correlated with or associated with objects and/or obstacles from one or more images or frames subsequently received in time.

The sensor fusion module 402 can fuse the objects and/or obstacles from the images obtained from the camera and/or point cloud data item obtained from the LiDAR sensors. For example, the sensor fusion module 402 may determine based on a location of two cameras that an image from one of the cameras comprising one half of a vehicle located in front of the autonomous vehicle is the same as the vehicle captured by another camera. The sensor fusion module 402 may send the fused object information to the tracking or prediction module 446 and the fused obstacle information to the occupancy grid module 460. The in-vehicle control computer may include the occupancy grid module 460 which can retrieve landmarks from a map database 458 stored in the in-vehicle control computer. The occupancy grid module 460) can determine drivable areas and/or obstacles from the fused obstacles obtained from the sensor fusion module 402 and the landmarks stored in the map database 458. For example, the occupancy grid module 460 can determine that a drivable area may include a speed bump obstacle.

As shown in FIG. 4 below the sensor fusion module 402, the in-vehicle control computer (350) in FIG. 3) may include a LiDAR-based object detection module 412 that can perform object detection 416 based on point cloud data item obtained from the LiDAR sensors 414 located on the autonomous vehicle. The object detection 416 technique can provide a location (e.g., in 3D world coordinates) of objects from the point cloud data item. Below the LiDAR-based object detection module 412, the in-vehicle control computer may include an image-based object detection module 418 that can perform object detection 424 based on images obtained from cameras 420 located on the autonomous vehicle. For example, the object detection 418 technique can employ a deep image-based object detection 424 (e.g., a machine learning technique) to provide a location (e.g., in 3D world coordinates) of objects from the image provided by the camera 420.

The radar 456 on the autonomous vehicle can scan an area surrounding the autonomous vehicle or an area towards which the autonomous vehicle is driven. The Radar data may be sent to the sensor fusion module 402 that can use the Radar data to correlate the objects and/or obstacles detected by the radar 456 with the objects and/or obstacles detected from both the LiDAR point cloud data item and the camera image. The Radar data also may be sent to the tracking or prediction module 446 that can perform data processing on the Radar data to track objects by object tracking module 448 as further described below.

The in-vehicle control computer may include a tracking or prediction module 446 that receives the locations of the objects from the point cloud and the objects from the image, and the fused objects from the sensor fusion module 402. The tracking or prediction module 446 also receives the Radar data with which the tracking or prediction module 446 can track objects by object tracking module 448 from one point cloud data item and one image obtained at one time instance to another (or the next) point cloud data item and another image obtained at another subsequent time instance.

The tracking or prediction module 446 may perform object attribute estimation 450 to estimate one or more attributes of an object detected in an image or point cloud data item. The one or more attributes of the object may include a type of object (e.g., pedestrian, car, or truck, etc.). The tracking or prediction module 446 may perform behavior prediction 452 to estimate or predict the motion pattern of an object detected in an image and/or a point cloud. The behavior prediction 452 can be performed to detect a location of an object in a set of images received at different points in time (e.g., sequential images) or in a set of point cloud data items received at different points in time (e.g., sequential point cloud data items). In some embodiments, the behavior prediction 452 can be performed for each image received from a camera and/or each point cloud data item received from the LiDAR sensor. In some embodiments, the tracking or prediction module 446 can be performed (e.g., run or executed) on received data to reduce computational load by performing behavior prediction 452 on every other or after every pre-determined number of images received from a camera or point cloud data item received from the LiDAR sensor (e.g., after every two images or after every three-point cloud data items).

The behavior prediction 452 feature may determine the speed and direction of the objects that surround the autonomous vehicle from the Radar data, where the speed and direction information can be used to predict or determine motion patterns of objects. A motion pattern may comprise a predicted trajectory information of an object over a pre-determined length of time in the future after an image is received from a camera. Based on the motion pattern predicted, the tracking or prediction module 446 may assign motion pattern situational tags to the objects (e.g., “located at coordinates (x,y),” “stopped,” “driving at 50 mph,” “speeding up” or “slowing down”). The situation tags can describe the motion pattern of the object. The tracking or prediction module 446 may send the one or more object attributes (e.g., types of the objects) and motion pattern situational tags to the planning module 462. The tracking or prediction module 446 may perform an environment analysis 454 using any information acquired by system 400 and any number and combination of its components.

The in-vehicle control computer may include the planning module 462 that receives the object attributes and motion pattern situational tags from the tracking or prediction module 446, the drivable area and/or obstacles, and the vehicle location and pose information from the fused localization module 426 (further described below).

The planning module 462 can perform navigation planning 464 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 464 may include determining an area next to the road where the autonomous vehicle can be safely parked in a case of emergencies. The planning module 462 may include behavioral decision making 466 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 462 performs trajectory generation 468 and selects a trajectory from the set of trajectories determined by the navigation planning operation 464. The selected trajectory information may be sent by the planning module 462 to the control module 470.

The in-vehicle control computer may include a control module 470) that receives the proposed trajectory from the planning module 462 and the autonomous vehicle location and pose from the fused localization module 426. The control module 470 may include a system identifier 472. The control module 470 can perform a model-based trajectory refinement 474 to refine the proposed trajectory. For example, the control module 470 can apply filtering (e.g., Kalman filter) to make the proposed trajectory data smooth and/or to minimize noise. The control module 470) may perform the robust control 476 by determining, based on the refined proposed trajectory information and current location and/or pose of the autonomous vehicle, an amount of brake pressure to apply, a steering angle, a throttle amount to control the speed of the vehicle, and/or a transmission gear. The control module 470 can send the determined brake pressure, steering angle, throttle amount, and/or transmission gear to one or more devices in the autonomous vehicle to control and facilitate precise driving operations of the autonomous vehicle.

The deep image-based object detection 424 performed by the image-based object detection module 418 can also be used detect landmarks (e.g., stop signs, speed bumps, etc.,) on the road. The in-vehicle control computer may include a fused localization module 426 that obtains landmarks detected from images, the landmarks obtained from a map database 436 stored on the in-vehicle control computer, the landmarks detected from the point cloud data item by the LiDAR-based object detection module 412, the speed and displacement from the odometer sensor 444, or a rotary encoder, and the estimated location of the autonomous vehicle from the GPS/IMU sensor 438 (i.e., GPS sensor 440 and IMU sensor 442) located on or in the autonomous vehicle. Based on this information, the fused localization module 426 can perform a localization operation 428 to determine a location of the autonomous vehicle, which can be sent to the planning module 462 and the control module 470.

The fused localization module 426 can estimate pose 430 of the autonomous vehicle based on the GPS and/or IMU sensors 438. The pose of the autonomous vehicle can be sent to the planning module 462 and the control module 470. The fused localization module 426 can also estimate status (e.g., location, possible angle of movement) of the trailer unit based on (e.g., trailer status estimation 434), for example, the information provided by the IMU sensor 442 (e.g., angular rate and/or linear velocity). The fused localization module 426 may also check the map content 432.

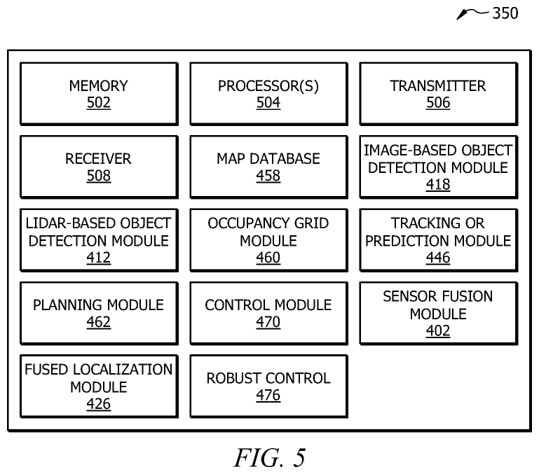

FIG. 5 shows an exemplary block diagram of an in-vehicle control computer 350 included in an autonomous vehicle 302. The in-vehicle control computer 350 may include at least one processor 504 and a memory 502 having instructions stored thereupon (e.g., software instructions 128 and processing instructions 380 in FIGS. 1 and 3, respectively). The instructions, upon execution by the processor 504, configure the in-vehicle control computer 350 and/or the various modules of the in-vehicle control computer 350 to perform the operations described in FIGS. 1-6. The transmitter 506 may transmit or send information or data to one or more devices in the autonomous vehicle. For example, the transmitter 506 can send an instruction to one or more motors of the steering wheel to steer the autonomous vehicle. The receiver 508 receives information or data transmitted or sent by one or more devices. For example, the receiver 508 receives a status of the current speed from the odometer sensor or the current transmission gear from the transmission. The transmitter 506 and receiver 508 also may be configured to communicate with the plurality of vehicle subsystems 340 and the in-vehicle control computer 350 described above in FIGS. 3 and 4.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. A system comprising:
a memory configured to store sensor data that provides information about a road ahead of an autonomous vehicle, wherein the sensor data is captured by at least one sensor associated with the autonomous vehicle; and
a processor associated with the autonomous vehicle, the processor operably coupled to the memory, and configured to:
access the sensor data:
determine that the sensor data comprises an indication of a person altering a traffic flow using a hand signal:
determine an interpretation of the hand signal:
determine a pose associated with the person:
determine that the hand signal is in use to alter the traffic flow based at least in part upon the determined interpretation of the hand signal and the determined pose associated with the person:
communicate the sensor data and the determined interpretation of the hand signal along with a first query message to an oversight server, wherein the first query message requests to verify the determined interpretation of the hand signal:
receive a first message that indicated that the determined interpretation of the hand signal is verified from the oversight server:
determine a proposed trajectory for the autonomous vehicle according to the determined interpretation of the hand signal:
determine, from the sensor data, whether any obstruction prevents navigating the autonomous vehicle according to the proposed trajectory; and
in response to determining that no obstruction is present that prevents navigating the autonomous vehicle according to the proposed trajectory, navigate the autonomous vehicle according to the proposed trajectory.

Clause 2. The system of Clause 1, wherein in response to determining that an obstruction prevents navigating the autonomous vehicle according to the proposed trajectory:
stop the autonomous vehicle;
wait until the sensor data indicates that the obstruction is no longer present; and
navigate the autonomous vehicle according to the proposed trajectory.

Clause 3. The system of Clause 1, wherein in response to determining that an object prevents navigating the autonomous vehicle according to the proposed trajectory, perform a minimal risk maneuver (MRC) operation.

Clause 4. The system of Clause 3, wherein the MRC operation comprises one of the following:
stopping the autonomous vehicle: or
pulling over the autonomous vehicle.

Clause 5. The system of Clause 1, wherein determining that the hand signal is in use to alter the traffic flow based at least in part upon the determined interpretation of the hand signal comprises determining that the interpretation of the hand signal is related to traffic movement comprising turning right, turning left, moving forward, stopping, reducing speed, or avoiding a construction zone.

Clause 6. The system of Clause 1, wherein determining that the hand signal is in use to alter the traffic flow based at least in part upon the pose associated with the person comprises determining that the pose associated with the person indicates that the person is facing toward oncoming traffic along the road.

Clause 7. The system of Clause 1, wherein determining the interpretation of the hand signal comprises:
extracting a first set of features from the sensor data, wherein:
the first set of features indicates the person is altering the traffic flow using the hand signal; and
the first set of features is represented in a first feature vector comprising a first set of numerical values:
accessing a training dataset that comprises a plurality of sample images, wherein for each sample image of the plurality of sample images:
a distinct hand signal is indicated; and
a label is assigned to a respective interpretation of the distinct hand signal shown:
extracting a second set of features from each sample image of the plurality of sample images, wherein for each sample image:
the second set of features indicates a category of the distinct hand signal; and
the second set of features is represented in a second feature vector comprising a second set of numerical values:
comparing the first feature vector with the second feature vector:
determining a distance between the first feature vector and the second feature vector:
in response to determining that the determined distance between the first feature vector and the second feature vector is less than a threshold distance, determining that the hand signal indicated in the sensor data corresponds to the distinct hand signal indicated in a particular sample image.

Clause 8. A method comprising:
accessing sensor data that provides information about a road ahead of an autonomous vehicle, wherein the sensor data is captured by at least one sensor associated with the autonomous vehicle:
determining that the sensor data comprises an indication of a person altering a traffic flow using a hand signal;
determining an interpretation of the hand signal;
determining a pose associated with the person:
determining that the hand signal is in use to alter the traffic flow based at least in part upon the determined interpretation of the hand signal and the determined pose associated with the person:
communicating the sensor data and the determined interpretation of the hand signal along with a first query message to an oversight server, wherein the first query message requests to verify the determined interpretation of the hand signal:
receiving a first message that indicated that the determined interpretation of the hand signal is verified from the oversight server:
determining a proposed trajectory for the autonomous vehicle according to the determined interpretation of the hand signal:
determining, from the sensor data, whether any obstruction prevents navigating the autonomous vehicle according to the proposed trajectory; and
in response to determining that no obstruction is present that prevents navigating the autonomous vehicle according to the proposed trajectory, navigating the autonomous vehicle according to the proposed trajectory.

Clause 9. The method of Clause 8, wherein the proposed trajectory follows the interpretation of the hand signal, such that:
if the interpretation of the hand signal is stop, the proposed trajectory is stopping the autonomous vehicle:
if the interpretation of the hand signal is slow down, the proposed trajectory is slowing down the autonomous vehicle; and
if the interpretation of the hand signal is turning left, the proposed trajectory is turning the autonomous vehicle to left.

Clause 10. The method of Clause 8, further comprising:
accessing a map data that is a virtual map of a city in which the autonomous vehicle is traveling,
determining a location of the autonomous vehicle; and
determining, from the map data, that the autonomous vehicle is traveling within a particular area where it is known that hand signals are used to control traffic, wherein the particular area comprises one of a school road crossing area, a construction area, an intersection, or a road accident area,
wherein determining that the hand signal is in use to alter the traffic flow is further based at least in part upon determining that the autonomous vehicle is traveling within the particular area.

Clause 11. The method of Clause 10, further comprising prioritizing an analysis of the sensor data for hand signal detection in response to determining that the autonomous vehicle is traveling within the particular area, wherein the sensor data is captured when the autonomous vehicle is traveling within the particular area.

Clause 12. The method of Clause 8, wherein the hand signal comprises one of the following:
hands held up in a manner that indicates that traffic should stop:
hand waving that indicates that traffic should commence and keep moving: or
hand motions that indicate a change in direction of traffic.

Clause 13. The method of Clause 8, wherein the at least one sensor comprises a camera, a light detection and ranging (LiDAR), an infrared sensor, a motion sensors, a Radar sensor.

Clause 14. The method of Clause 8, wherein the sensor data comprises at least one of a video feed, an image feed, a light detection and ranging (LiDAR) cloud data feed, an infrared data feed, a motion sensor data feed, or a Radar sensor data feed.

Clause 15. A non-transitory computer-readable medium storing instructions that when executed by a processor cause the processor to:
access sensor data that provides information about a road ahead of an autonomous vehicle, wherein the sensor data is captured by at least one sensor associated with the autonomous vehicle:
determine that the sensor data comprises an indication of a person altering a traffic flow using a hand signal:
determine an interpretation of the hand signal:
determine a pose associated with the person:
determine that the hand signal is in use to alter the traffic flow based at least in part upon the determined interpretation of the hand signal and the determined pose associated with the person:
communicate the sensor data and the determined interpretation of the hand signal along with a first query message to an oversight server, wherein the first query message requests to verify the determined interpretation of the hand signal;
receive a first message that indicated that the determined interpretation of the hand signal is verified from the oversight server:
determine a proposed trajectory for the autonomous vehicle according to the determined interpretation of the hand signal:
determine, from the sensor data, whether any obstruction prevents navigating the autonomous vehicle according to the proposed trajectory; and
in response to determining that no obstruction is present that prevents navigating the autonomous vehicle according to the proposed trajectory, navigate the autonomous vehicle according to the proposed trajectory.

Clause 16. The non-transitory computer-readable medium of Clause 15, wherein
the hand signal is originated by one of the following:
a construction worker:
a law enforcement officer:
a traffic officer:
a pedestrian:
a driver of a vehicle: or
a rider of a bicycle.

Clause 17. The non-transitory computer-readable medium of Clause 15, wherein the proposed trajectory comprises one of the following:
slowing down:
stopping:
pulling over:
changing route: or
changing lane while staying on a predetermined route.

Clause 18. The non-transitory computer-readable medium of Clause 15, wherein the instructions further cause the processor to communicate the verified interpretation of the hand signal and the verified proposed trajectory to one or more autonomous vehicle that are traveling toward a location where the hand signal is in use to alter the traffic flow.

Clause 19. The non-transitory computer-readable medium of Clause 15, wherein: determining that the hand signal is in use to alter the traffic flow based at least in part upon the pose associated with the person comprises determining that the pose associated with the person indicates that the person is facing toward oncoming traffic along the road; and the oncoming traffic comprises a traffic flow that includes a direction in which the autonomous vehicle is currently travelling.

Clause 20. The non-transitory computer-readable medium of Clause 15, wherein:
determining the pose associated with the person comprises determining that the person is facing toward the oncoming traffic or facing away from the oncoming traffic:
determining that the hand signal is in use to alter the traffic flow is in response to determining that the person is facing toward the oncoming traffic; and
the instructions further cause the processor to determine that hand signal is not in use to alter the traffic flow in response to determining that the person is facing away from the oncoming traffic.

1. A system comprising:
a memory configured to store sensor data that provides information about a road ahead of an autonomous vehicle, wherein the sensor data is captured by at least one sensor associated with the autonomous vehicle; and
a processor associated with the autonomous vehicle, the processor operably coupled to the memory, and configured to:
access the sensor data:
determine that the sensor data comprises an indication of a person altering a traffic flow using a hand signal:
determine an interpretation of the hand signal:
determine a pose associated with the person:
determine that the hand signal is in use to alter the traffic flow based at least in part upon the determined interpretation of the hand signal and the determined pose associated with the person:
communicate the sensor data and the determined interpretation of the hand signal along with a first query message to an oversight server, wherein the first query message requests to verify the determined interpretation of the hand signal:
receive a first message that indicated that the determined interpretation of the hand signal is verified from the oversight server:
determine a proposed trajectory for the autonomous vehicle according to the determined interpretation of the hand signal;
determine, from the sensor data, whether any obstruction prevents navigating the autonomous vehicle according to the proposed trajectory; and
in response to determining that no obstruction is present that prevents navigating the autonomous vehicle according to the proposed trajectory, navigate the autonomous vehicle according to the proposed trajectory.

2. The system of claim 1, wherein in response to determining that an obstruction prevents navigating the autonomous vehicle according to the proposed trajectory:
stop the autonomous vehicle;
wait until the sensor data indicates that the obstruction is no longer present; and
navigate the autonomous vehicle according to the proposed trajectory.

3. The system of claim 1, wherein in response to determining that an object prevents navigating the autonomous vehicle according to the proposed trajectory, perform a minimal risk maneuver (MRC) operation.

4. The system of claim 3, wherein the MRC operation comprises one of the following:
stopping the autonomous vehicle; or
pulling over the autonomous vehicle.

5. The system of claim 1, wherein determining that the hand signal is in use to alter the traffic flow based at least in part upon the determined interpretation of the hand signal comprises determining that the interpretation of the hand signal is related to traffic movement comprising turning right, turning left, moving forward, stopping, reducing speed, or avoiding a construction zone.

6. The system of claim 1, wherein determining that the hand signal is in use to alter the traffic flow based at least in part upon the pose associated with the person comprises determining that the pose associated with the person indicates that the person is facing toward oncoming traffic along the road.

7. The system of claim 1, wherein determining the interpretation of the hand signal comprises:
extracting a first set of features from the sensor data, wherein:
the first set of features indicates the person is altering the traffic flow using the hand signal; and
the first set of features is represented in a first feature vector comprising a first set of numerical values:
accessing a training dataset that comprises a plurality of sample images, wherein for each sample image of the plurality of sample images:
a distinct hand signal is indicated; and
a label is assigned to a respective interpretation of the distinct hand signal shown;
extracting a second set of features from each sample image of the plurality of sample images, wherein for each sample image:
the second set of features indicates a category of the distinct hand signal; and
the second set of features is represented in a second feature vector comprising a second set of numerical values;
comparing the first feature vector with the second feature vector;
determining a distance between the first feature vector and the second feature vector;
in response to determining that the determined distance between the first feature vector and the second feature vector is less than a threshold distance, determining that the hand signal indicated in the sensor data corresponds to the distinct hand signal indicated in a particular sample image.

8. A method comprising:
accessing sensor data that provides information about a road ahead of an autonomous vehicle, wherein the sensor data is captured by at least one sensor associated with the autonomous vehicle:
determining that the sensor data comprises an indication of a person altering a traffic flow using a hand signal;
determining an interpretation of the hand signal:
determining a pose associated with the person:
determining that the hand signal is in use to alter the traffic flow based at least in part upon the determined interpretation of the hand signal and the determined pose associated with the person:
communicating the sensor data and the determined interpretation of the hand signal along with a first query message to an oversight server, wherein the first query message requests to verify the determined interpretation of the hand signal:
receiving a first message that indicated that the determined interpretation of the hand signal is verified from the oversight server:
determining a proposed trajectory for the autonomous vehicle according to the determined interpretation of the hand signal;
determining, from the sensor data, whether any obstruction prevents navigating the autonomous vehicle according to the proposed trajectory; and
in response to determining that no obstruction is present that prevents navigating the autonomous vehicle according to the proposed trajectory, navigating the autonomous vehicle according to the proposed trajectory.

9. The method of claim 8, wherein the proposed trajectory follows the interpretation of the hand signal, such that:
if the interpretation of the hand signal is stop, the proposed trajectory is stopping the autonomous vehicle:
if the interpretation of the hand signal is slow down, the proposed trajectory is slowing down the autonomous vehicle; and
if the interpretation of the hand signal is turning left, the proposed trajectory is turning the autonomous vehicle to left.

10. The method of claim 8, further comprising:
accessing a map data that is a virtual map of a city in which the autonomous vehicle is traveling,
determining a location of the autonomous vehicle; and
determining, from the map data, that the autonomous vehicle is traveling within a particular area where it is known that hand signals are used to control traffic, wherein the particular area comprises one of a school road crossing area, a construction area, an intersection, or a road accident area,
wherein determining that the hand signal is in use to alter the traffic flow is further based at least in part upon determining that the autonomous vehicle is traveling within the particular area.

11. The method of claim 10, further comprising prioritizing an analysis of the sensor data for hand signal detection in response to determining that the autonomous vehicle is traveling within the particular area, wherein the sensor data is captured when the autonomous vehicle is traveling within the particular area.

12. The method of claim 8, wherein the hand signal comprises one of the following:
hands held up in a manner that indicates that traffic should stop:
hand waving that indicates that traffic should commence and keep moving: or
hand motions that indicate a change in direction of traffic.

13. The method of claim 8, wherein the at least one sensor comprises a camera, a light detection and ranging (LiDAR), an infrared sensor, a motion sensors, a Radar sensor.

14. The method of claim 8, wherein the sensor data comprises at least one of a video feed, an image feed, a light detection and ranging (LiDAR) cloud data feed, an infrared data feed, a motion sensor data feed, or a Radar sensor data feed.

15. A non-transitory computer-readable medium storing instructions that when executed by a processor cause the processor to:
access sensor data that provides information about a road ahead of an autonomous vehicle, wherein the sensor data is captured by at least one sensor associated with the autonomous vehicle:
determine that the sensor data comprises an indication of a person altering a traffic flow using a hand signal:
determine an interpretation of the hand signal:
determine a pose associated with the person:
determine that the hand signal is in use to alter the traffic flow based at least in part upon the determined interpretation of the hand signal and the determined pose associated with the person:
communicate the sensor data and the determined interpretation of the hand signal along with a first query message to an oversight server, wherein the first query message requests to verify the determined interpretation of the hand signal:
receive a first message that indicated that the determined interpretation of the hand signal is verified from the oversight server:
determine a proposed trajectory for the autonomous vehicle according to the determined interpretation of the hand signal:
determine, from the sensor data, whether any obstruction prevents navigating the autonomous vehicle according to the proposed trajectory; and
in response to determining that no obstruction is present that prevents navigating the autonomous vehicle according to the proposed trajectory, navigate the autonomous vehicle according to the proposed trajectory.

16. The non-transitory computer-readable medium of claim 15, wherein the hand signal is originated by one of the following:
a construction worker;
a law enforcement officer;
a traffic officer;
a pedestrian;
a driver of a vehicle; or
a rider of a bicycle.

17. The non-transitory computer-readable medium of claim 15, wherein the proposed trajectory comprises one of the following:
slowing down;
stopping;
pulling over;
changing route; or
changing lane while staying on a predetermined route.

18. The non-transitory computer-readable medium of claim 15, wherein the instructions further cause the processor to communicate the verified interpretation of the hand signal and the verified proposed trajectory to one or more autonomous vehicle that are traveling toward a location where the hand signal is in use to alter the traffic flow.

19. The non-transitory computer-readable medium of claim 15, wherein:
determining that the hand signal is in use to alter the traffic flow based at least in part upon the pose associated with the person comprises determining that the pose associated with the person indicates that the person is facing toward oncoming traffic along the road; and
the oncoming traffic comprises a traffic flow that includes a direction in which the autonomous vehicle is currently travelling.

20. The non-transitory computer-readable medium of claim 15, wherein:
determining the pose associated with the person comprises determining that the person is facing toward the oncoming traffic or facing away from the oncoming traffic;
determining that the hand signal is in use to alter the traffic flow is in response to determining that the person is facing toward the oncoming traffic; and
the instructions further cause the processor to determine that hand signal is not in use to alter the traffic flow in response to determining that the person is facing away from the oncoming traffic.
